(19) United States
(12) Patent Application Publication
(10) Pub. No.: US 2020/0037103 A1
(43) Pub. Date: Jan. 30, 2020

(54) SYSTEM FOR PRESENCE AND POSITION TRACKING IN FACILITIES

(71) Applicants: Reza RAJI, San Francisco, CA (US); Gerry GUTT, San Francisco, CA (US); Howard HERRERA, San Francisco, CA (US); Asako HAYASHI, San Francisco, CA (US); Robert Hazbun, San Francisco, CA (US)

(72) Inventors: Reza RAJI, San Francisco, CA (US); Gerry GUTT, San Francisco, CA (US); Howard HERRERA, San Francisco, CA (US); Asako HAYASHI, San Francisco, CA (US); Robert Hazbun, San Francisco, CA (US)

(21) Appl. No.: 15/871,563

(22) Filed: Jan. 15, 2018

Related U.S. Application Data
(63) Continuation-in-part of application No. 15/654,340, filed on Jul. 19, 2017.
(60) Provisional application No. 62/446,643, filed on Jan. 16, 2017.
(60) Provisional application No. 62/446,671, filed on Jan. 16, 2017.
(60) Provisional application No. 62/446,690, filed on Jan. 16, 2017.
(60) Provisional application No. 62/471,634, filed on Mar. 15, 2017.
(60) Provisional application No. 62/471,645, filed on Mar. 15, 2017.
(60) Provisional application No. 62/471,660, filed on Mar. 15, 2017.
(60) Provisional application No. 62/472,200, filed on Mar. 16, 2017.
(60) Provisional application No. 62/472,207, filed on Mar. 16, 2017.
(60) Provisional application No. 62/472,216, filed on Mar. 16, 2017.
(60) Provisional application No. 62/503,414, filed on May 9, 2017.

(51) Int. Cl. H04W 4/02; H04W 4/80; H04W 4/029

(52) U.S. Cl. CPC H04W 4/023; H04W 4/23; H04W 4/029; H04W 4/80

(57) ABSTRACT

Embodiments include a system comprising a mobile application configured to run on a plurality of mobile devices, and a device array comprising a plurality of devices installed in a premises. Each device includes a communication device configured to communicate with the plurality of mobile devices at the premises using the mobile application. The system includes a cloud platform coupled to the device array via a remote network. The cloud platform is remote to the premises and includes a platform program configured to use device array data from the plurality of devices and mobile device data from the mobile application to detect presence and track real-time position of the plurality of mobile devices in the premises.

### RELATED APPLICATIONS

This application is a continuation in part of U.S. patent application Ser. No. 15/654,340, filed Jul. 19, 2017, which claims the benefit of U.S. Patent Application No. 62/364,264, filed Jul. 19, 2016.

This application claims the benefit of U.S. Patent Application No. 62/446,643, filed Jan. 16, 2017.

This application claims the benefit of U.S. Patent Application No. 62/446,671, filed Jan. 16, 2017.

This application claims the benefit of U.S. Patent Application No. 62/446,690, filed Jan. 16, 2017.

This application claims the benefit of U.S. Patent Application No. 62/471,634, filed Mar. 15, 2017.

This application claims the benefit of U.S. Patent Application No. 62/471,645, filed Mar. 15, 2017.

This application claims the benefit of U.S. Patent Application No. 62/471,660, filed Mar. 15, 2017.

This application claims the benefit of U.S. Patent Application No. 62/472,200, filed Mar. 16, 2017.

This application claims the benefit of U.S. Patent Application No. 62/472,207, filed Mar. 16, 2017.

This application claims the benefit of U.S. Patent Application No. 62/472,216, filed Mar. 16, 2017.

This application claims the benefit of U.S. Patent Application No. 62/503,414, filed May 9, 2017.

### FIELD OF THE INVENTION

The present invention generally relates to establishing Internet-of-Things (IOT) devices and, more particularly, to establishing in a facility presence detection and tracking systems incorporating IOT technology.

### BACKGROUND

Most public or commercial facilities or premises lack detailed presence or tracking information relating to occupants of the facility because of the technical difficulties associated with indoor positioning. These commercial facilities include but are not limited to retail shops or stores, department stores, big box retailers, grocery stores or outlets, office buildings, healthcare facilities like hospitals, hospitality and entertainment venues, and travel hubs (e.g., airports, train stations, etc.). When considering retail facilities, and in contrast to the typical online shopping experience that is considered organized and efficient, the lack of presence and position information of consumers in a physical facility leads to an in-store consumer experience that is random and unmanaged. Consequently, the online to offline consumer journey is broken as little or no innovation is applied to retail marketing, leading to the absence of an effective branded channel for digitally engaging shoppers at locations. Furthermore, when considering other types of facilities (e.g., office buildings, healthcare facilities, etc.), security issues can arise from a lack of presence and position information of occupants in those facilities. Conventional technologies involving packet sniffing and proximity beaconing are insufficient for providing presence and position information, in addition to being unscalable and coarse.

Therefore what is needed is a system and method for efficiently determining presence and position or location information of occupants of a facility.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A is a block diagram of the presence and position tracking system (“PPTS”), under an embodiment.

FIG. 1B shows an example deployment of PPTS components (e.g., Dot, Bolt, Bolt Solo, Snap, Dash, Cube, gateway, etc.) in a facility, under an embodiment.

FIG. 1C shows an example deployment of the PPTS in a retail establishment, under an embodiment.

FIG. 1D shows example user interface (UI) components presented by the retailer app corresponding to a PPTS deployment in a retail establishment, under an embodiment.

FIG. 2A is a block diagram of a Dot, under an embodiment.

FIG. 2B is an isometric view of a first side of Dot components, under an embodiment.

FIG. 2C is an isometric view of a second side of Dot components, under an embodiment.

FIG. 2D is a representation of printed circuit board (PCB) configuration of the Dot, under an embodiment.

FIG. 2E is an isometric view of a Bolt Solo, under an embodiment.

FIG. 2F shows the Bolt and Snap devices, under an embodiment.

FIG. 2G is an isometric top view of a Bolt in the second configuration, under an embodiment.

FIG. 2H is an alternative isometric top view of the Bolt in the second configuration, under an embodiment.

FIG. 2I is an isometric view of a Dash device (left) configured for integration into an OEM troffer light (right), under an embodiment.

FIG. 2J is an isometric view of a Cube device (left) configured for integration into an OEM down light (right), under an embodiment.

FIG. 3 is shows a mobile device establishing or provisioning a group of deployed devices positioned in a regular pattern and communicating with a computer network, under an embodiment.

FIG. 4 is a block diagram of a provisioning device configured as a provisioning device to establish the Bolts, under an embodiment.

FIG. 5 is a flow diagram for using a provisioning device to establish Bolts, under an embodiment.

FIG. 6 is a flow diagram for one or more of the Bolts to receive an address and become established to connect and communicate with a network, under an embodiment.

FIG. 7 is a block diagram of the cloud-based platform program, under an embodiment.

FIG. 8 is an example site map of the platform program, under an embodiment.

FIG. 9 is an example zone map of the platform program, under an embodiment.

FIG. 10A is an example of campaign generation of the platform program, under an embodiment.

FIG. 10B is an example of campaign notification generation of the platform program, under an embodiment.

FIG. 11 is an example analytical data presentation of the platform program analytical data, under an embodiment.

FIG. 12 is an example traffic map of the platform program analytical data, under an embodiment.

FIG. 13 is an example heat map of the platform program analytical data, under an embodiment.

FIG. 14 is an example user interface presented by the mobile application and configured to provide contextual engagement information relating to the premises, under an embodiment.

FIG. 15 is an example user interface presented on the mobile device and configured to provide contextual engagement information including item information corresponding to an item searched on via the interface, and turn-by-turn instructions to navigate to the item in the premises, under an embodiment.

FIG. 16 is an example user interface presented on the mobile device and configured to provide a concierge icon or button, under an embodiment.

### DETAILED DESCRIPTION

Embodiments enable facility owners and managers by providing them with accurate information or data on the presence of individuals in their facility and activity of the individuals while in the facility. This presence and activity data enables the managers to provide a better in-person experience, in the case of retailers, and a more controlled and secure environment, in the case of retail and non-retail facilities. In particular, the presence and activity data enables brick-and-mortar retailers in many of the same ways as online retailers by providing them with detailed and accurate data on the identity of shoppers in their outlet and the activity of those shoppers while in the outlet (e.g., merchandise viewed, assistance needed, etc.). In turn this provides a much-improved experience for a shopper by enabling them to be provided with real-time on-site assistance at the merchandise as well as targeted discount opportunities on merchandise in which they have shown interest during a visit. Thus, embodiments herein provide significant improvements to shopper expectations regarding service, personalization, and a friction-less experience.

Embodiments include a presence and position tracking system (“system” or “PPTS”) configured to enable facility owners and managers by providing them with accurate information or data on presence and activity or position of the individuals while in the facility. This presence and activity data enables facility personnel and managers to provide an improved in-person experience in the case of retailers, and a more controlled and secure environment in the case of retail and non-retail facilities. In particular, the presence and activity data enables brick-and-mortar retailers in many of the same ways as online retailers by providing them with detailed and accurate data on the presence and identity of shoppers in their retail establishment and the activity of those shoppers while in the establishment (e.g., areas of store visited and time spent in areas, merchandise viewed, assistance needed, etc.). In turn this provides a much-improved experience for a visitor or shopper by enabling them to receive real-time on-site assistance at the merchandise as well as targeted discount and buying opportunities on types of merchandise in which they have shown an interest during a visit. Thus, embodiments described herein provide significant improvements to shopper expectations regarding service, personalization, and a friction-less experience.

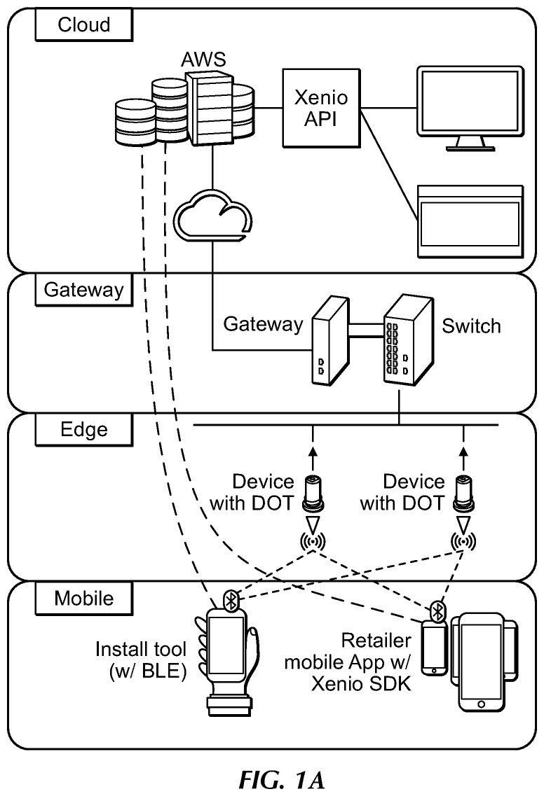

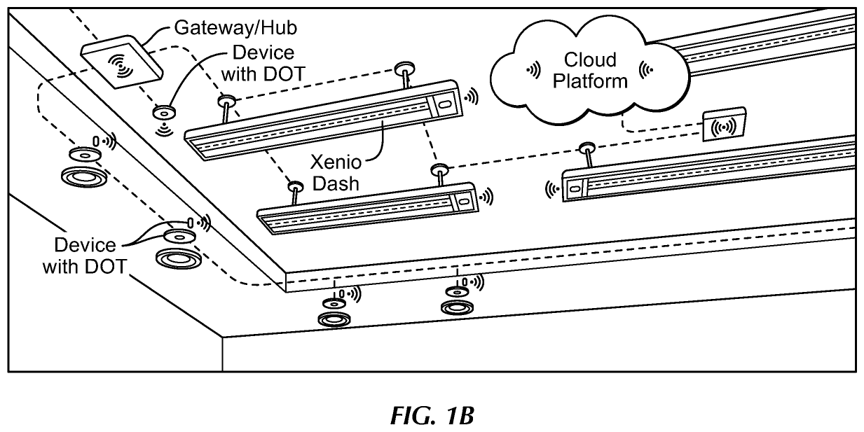

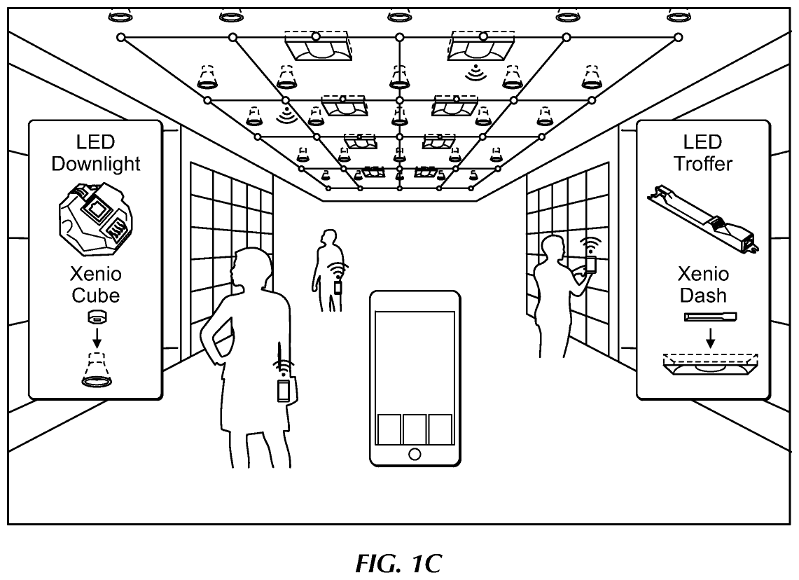

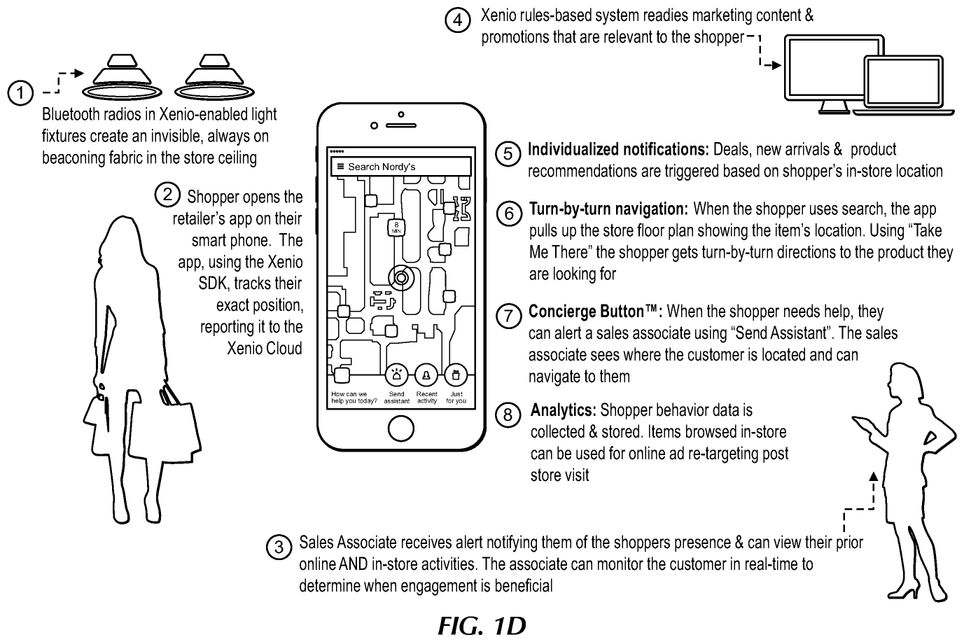

Embodiments include a uniform, invisible positioning “fabric” in a facility, and this fabric of devices is coupled to a cloud device or cloud-based platform (“cloud platform”). FIG. 1A is a block diagram of the presence and position tracking system (“PPTS” or “system”), under an embodiment. FIG. 1B shows an example deployment of PPTS components (e.g., Dot, Bolt, Bolt Solo, Snap, Dash, Cube, gateway, etc.) in a facility, under an embodiment. FIG. 1C shows an example deployment of the PPTS in a retail establishment, under an embodiment. The PPTS generally includes an array or fabric of beacons installed in the ceiling or ceiling components and coupled or connected to the cloud platform. The beacon array is a high-density array of Internet-of-Things (IOT) devices but is not so limited and, as such, is analogous to a constellation of positioning satellites. In contrast to conventional proximity detection, which is binary and coarse, the PPTS provides detailed and accurate presence and positioning information inside the host facility through use of the beacon array.

Each beacon of an embodiment is a low-energy, Bluetooth-enabled device configured to operate in an always-on state, and to communicate with a facility-related mobile application (“retailer app” or “mobile app”). The mobile application is configured for installation and operation (e.g., via download, etc.) on a portable electronic device (e.g., smart phone, tablet computer, etc.) (“mobile device”), for example a mobile device of a consumer, customer, and/or facility personnel. Each beacon is also configured to communicate with the cloud platform. The PPTS components of embodiments are purpose-built, thereby enabling support in different facility or retail environments through the provision of better signal coverage and less blockage. Thus, the PPTS is configured for presence detection and real-time tracking inside facilities including but not limited to retail shops or stores, department stores, big box retailers, grocery stores or outlets, office buildings, healthcare facilities like hospitals, hospitality and entertainment venues, and travel hubs (e.g., airports, train stations, etc.). The presence detection and real-time tracking data is securely received and capable of being used for operational and analytical purposes as applied to one or more of the retail shopping experience, facility security, and personnel monitoring to name a few.

Using an example in which the beacon array is deployed in a retail outlet, the retailer supplies an app (“retailer app”) for installation by consumers on their mobile devices. The retailer app includes a PPTS module or app component configured to communicate with the PPTS components (e.g., beacons, platform, gateway, etc.). More particularly, the retailer app, by virtue of the PPTS app component, communicates with the PPTS platform to provide positioning information for the mobile device hosting the retailer app, and hence the corresponding consumer. The PPTS platform is thus configured to continuously or nearly-continuously determine the presence and accurate position of consumers in the retail outlet (e.g., position accuracy within a few feet), and push information to a mobile device of the consumer based on the presence and position information. FIG. 1D shows example user interface (UI) components presented by the retailer app corresponding to a PPTS deployment in a retail establishment, under an embodiment.

The PPTS is configured to enable retailers, for example, with Presence-Based Marketing (PBM). PBM lets retailers and other consumer-traffic-intensive locations engage shoppers with location-smart content and custom offers, help shoppers find products and get help within indoor spaces, continue online engagement with shoppers after and between visits, and exploit technology to better understand in-store behaviors. PBM implementation under embodiments herein includes the PPTS app component for inclusion or integration into a retailer app (e.g., iOS, Android, etc.) and/or a software development kit (“PPTS SDK) configured for use by retailers to embed PPTS and PBM functionality within their retailer apps, as described in detail herein. Via a backend system or interface (e.g., web-based, portal, etc.), the PPTS is configured to provide rules-based marketing in which retailer personnel set up the environment and define rules (e.g., “if this, then that”, etc.) for pushing location- and context-aware messages to consumers devices.

The PPTS includes an array of beacons (e.g., Dot, Bolt, Bolt Solo, Snap, Dash, Cube, etc.) installed in a surface of the host premises. The surface includes a ceiling component, for example, and the ceiling component includes at least one of a tile, plank, panel, drop panel, grate, grid, beam, track, and support structure. The surface also includes a surface or housing (e.g., internal, external, etc.) of a system or subsystem installed in the ceiling (e.g., lighting, security, home control, environmental control, audio/video, fixture, etc.). A particular beacon embodiment described in detail herein, and referred to herein as the Dot, includes components forming a beacon configured in a surface-mount configuration to be installed and used independent of any other system or subsystem in the facility. The surface-mount configuration enables easy beacon installation on a surface, in a surface, on another system or subsystem, and/or in another system or subsystem. An example of mounting on/in a surface includes installation of the Dot in the Bolt configuration, as described herein, in ceiling tiles using the ceiling tile as the support frame or structure, thereby making beacon presence inconspicuous. This solves any problems relating to wiring because the beacons of an embodiment are wired together above the dropped ceiling surface, and solves any aesthetic problems because the beacon body can be a same or similar color as the ceiling surface.

The beacons are configured as edge devices and as such are coupled or connected to a gateway or switch. The gateway of an embodiment is a local gateway at the premises, but is not so limited as it can be located remotely (e.g., component of cloud platform). The gateway in turn is coupled or connected via a remote network or channel(s) to cloud-based processing devices including the cloud platform. The remote network or channel(s) includes, for example, one or more of wide area networks (WANs), broadband channels, and cellular channels, to name a few.

The beacons are also configured to couple to the mobile devices present in the premises and including the retailer app. The mobile devices include one or more of smart phones, tablet computers, smart watches, and wearable computing devices, but are not so limited. The retailer app (e.g., iOS, Android, etc.) is downloadable to the mobile device from a remote server (e.g., app store, etc.), for example, and is configured to include or integrate a PPTS module or component with app components relating to the facility (e.g., maps, merchandise information, promotional campaigns, etc.) and. The PPTS component, which in an embodiment includes a positioning engine configured for presence and accurate position determination of the host mobile device, is developed using a SDK of the PPTS (“PPTS SDK”), but is not so limited. The PPTS component of the retailer app is configured to communicate with the PPTS components via one or more of the Dots and the cloud equipment via alternative communication couplings or channels (e.g., broadband channels, WiFi, cellular channels, etc.). This configuration enables the PPTS to continuously or nearly-continuously determine a position of consumers in the facility, delivering position accuracy within a few feet.

In addition to the mobile devices of consumers, the PPTS includes a facility representative application or app configured for use by individuals operating or working at the facility. The facility representative app, referred to herein as the “associate app”, is hosted on one or more of a smart phone and tablet computer of a facility representative (e.g., retail associate, facility personnel or workforce, security personnel, healthcare professional, etc.).

The PPTS further includes a “provisioning app”, also referred to herein as the installer app, configured for large-scale beacon management when installing the array of beacons at the facility. The provisioning app of an embodiment is a component of the associate app, but is not so limited. Alternatively, the provisioning app is a stand-alone app is hosted on one or more of a smart phone and tablet computer of those installing and configuring the PPTS in the facility, and the portable computing device with the installed provisioning app is referred to herein as the provisioning device.

The beacon of an embodiment is a device comprising a housing or body including a communication device, and configured for installation in a premises to track real-time position of mobile devices in the premises. Circuitry in the housing is coupled to the communication device. The circuitry is configured to control the communication device to communicate over a first channel with the mobile devices. The circuitry is also configured to communicate over a second channel with the cloud platform. The beacon housing is configured for surface installation at least one of in and through a surface including a ceiling component, for example. The ceiling component includes at least one of a tile, plank, panel, drop panel, grate, grid, beam, and support structure, but is not so limited.

The description that follows references the beacon in the Dot configuration, which comprises a surface-mount device configured to be installed and used independent of any other system or subsystem in the facility. However, it is understood that the description applies to any beacon hereunder and described herein regardless of configuration and/or form factor and including, but not limited to, the Dot, Bolt, Bolt Solo, Snap, Dash, and Cube, to name a few.

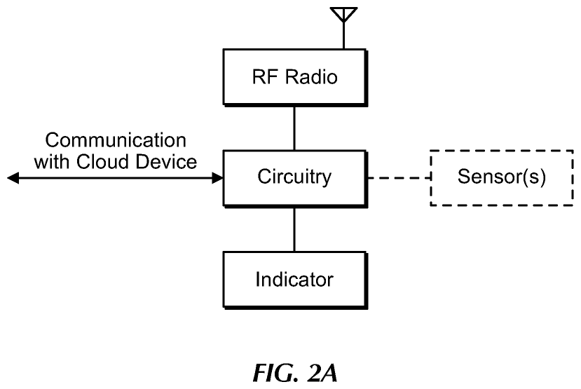

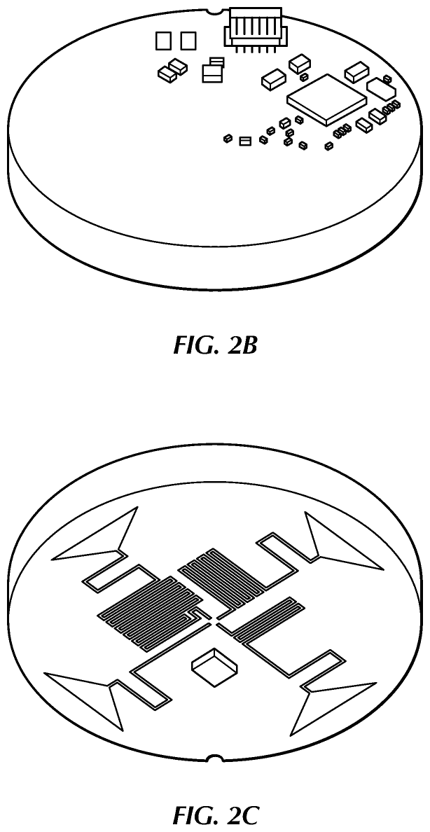

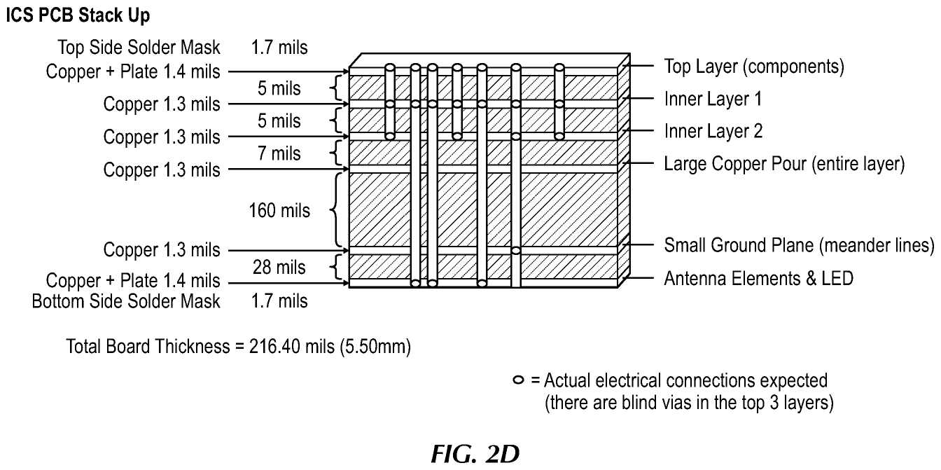

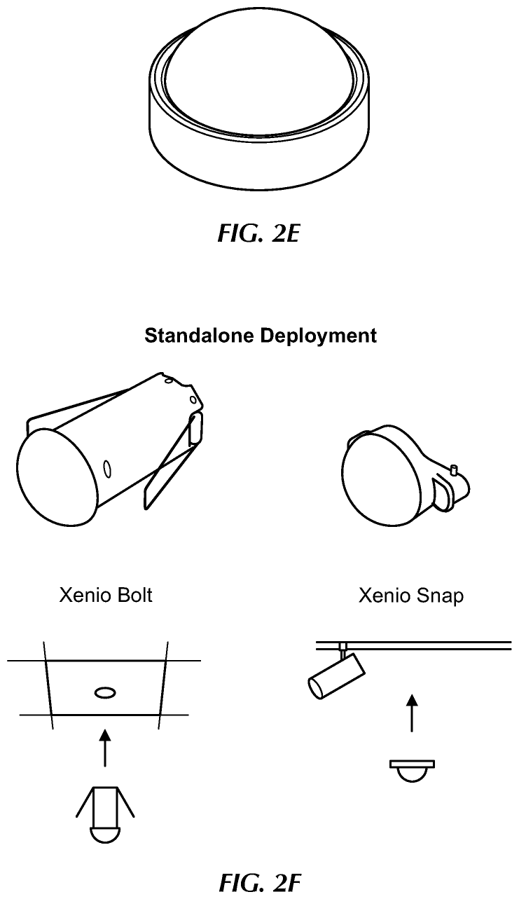

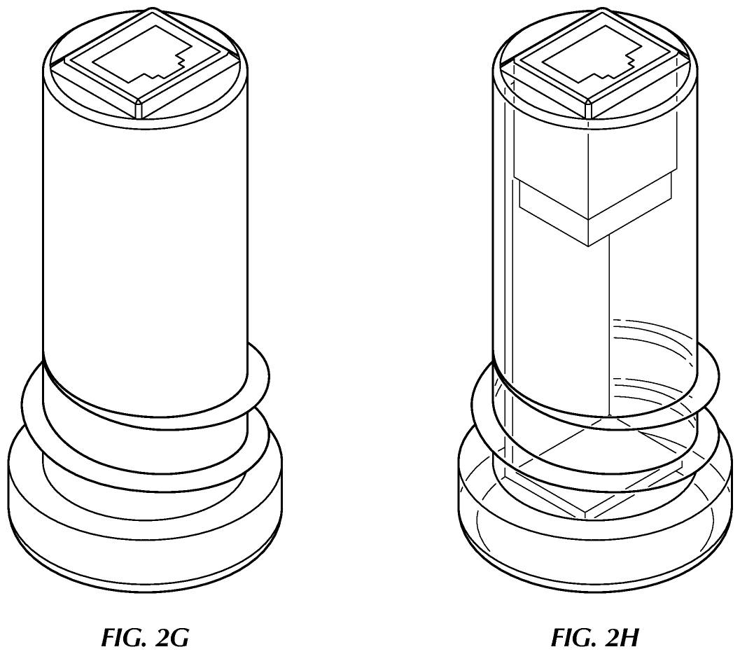

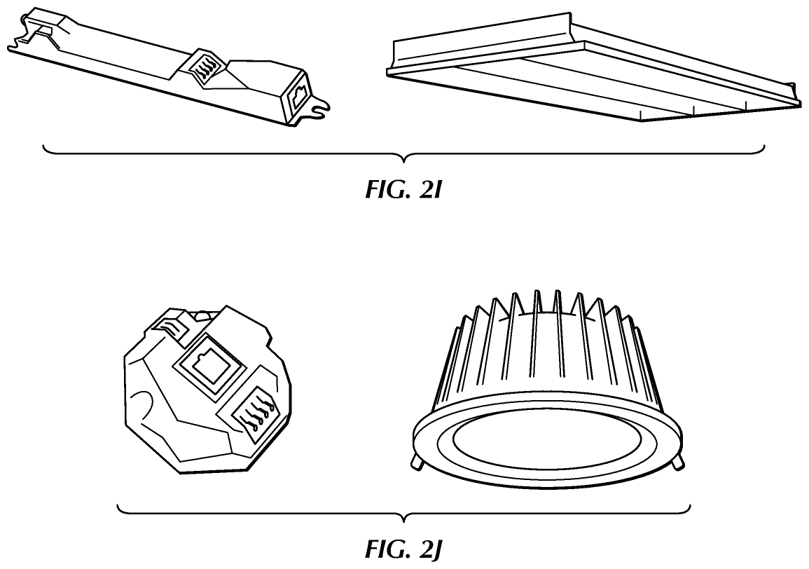

FIG. 2A is a block diagram of a Dot, under an embodiment. FIG. 2B is an isometric view of a first side of Dot components, under an embodiment. FIG. 2C is an isometric view of a second side of Dot components, under an embodiment. FIG. 2D is a representation of printed circuit board (PCB) configuration of the Dot, under an embodiment. The Dot includes a processor coupled or connected to a communication device and associated components. The communication device includes one or more components of a radio frequency (RF) communication device, for example at least one transmitter, receiver, and memory, but is not so limited. The communication device includes and/or is coupled and/or connected to at least one antenna, including an internal antenna, but alternative embodiments include an antenna with at least a portion of the antenna external to the housing. The antenna includes an antenna and ground plane, along with appropriate antenna-to-ground plane dielectric separation, but alternative embodiments include an antenna with at least a portion of the antenna external to the housing.

The communication device of the Dot includes a Bluetooth radio coupled or connected to circuitry in the housing as well as to an antenna comprising a Bluetooth low energy antenna. The communication device of an embodiment also includes components configured as and/or to participate in a mesh network (wired and/or wireless) in which the host Dot (node) cooperates in distribution of data in/through the network by relaying data for a coupled network, component(s), and/or device(s).

The Dot further includes an indicator comprising one or more of a visual and audible indicator coupled to the circuitry. An embodiment includes a visual indicator positioned in an end region of the Dot, and the indicator includes a light-emitting diode (LED) for example (e.g., RGB LED, etc.), but is not so limited. The Dot is configured to control the visual indicator to illuminate only during provisioning as described herein, and otherwise the indicator remains in the off state to enable the Dot to be very inconspicuous.

As described in detail herein, the communication device transmits or sends an outgoing signal including a unique identifier of the Dot, and receives an incoming signal containing an address. The Dot circuitry (e.g., processor, memory, etc.) associates the address received the unique identifier. The outgoing signal can include more information than the unique identifier of the Dot. Similarly, the incoming signal can include more information than the address to be assigned to the Dot with the unique identifier.

The Dot circuitry includes, for example, a processor and a memory configured to process information transmitted and received by the Dot. The circuitry includes component(s) configured as control circuitry for selectively controlling a state of the indicator (enabled during provisioning of the beacon) based on information and data of the beacon and/or the corresponding system. The illumination states include at least one of illuminated, off, at least one illumination level, at least one color, and alternating between two or more states. A lens or translucent region is coupled or connected to the housing and is positioned adjacent the visual indicator. The lens is configured to diffuse light of the indicator, and in an embodiment is frosted or otherwise opaque (e.g., coating, color, etc.). The Dot of an embodiment includes an audible indicator in addition to the visual indicator or, alternatively, instead of the visual indicator.

The Dot includes a coupling or connector configured to connect or couple to one or more of the gateway and cloud platform. In an embodiment the Dot is coupled to the cloud platform via a gateway device as described herein, but is not so limited. The gateway includes a local gateway or switch but, alternatively, includes a remote gateway (e.g., cloud-based gateway). The Dot is coupled or connected to the local gateway via one or more of a wire or cable, or a wireless channel. In this manner, the Dot is configured to be controlled from and provide data to one or more of the cloud platform and gateway.

The Dot is dynamically configurable to be powered with an external power source and/or an internal power source and, as such, includes a removeably coupled power module. When a Dot installation is to be powered by an external power source, an external power module is coupled to the Dot prior/during installation, and the external power module includes one or more couplings and/or connectors appropriate to the external power source. For example, the Dot of an embodiment is powered via an external power source comprising a Power-over-Ethernet (POE) (e.g., passive, active, etc.) device.

When a Dot installation is to be powered by an internal or on-board power source, an internal power module is coupled to the Dot prior/during installation. The internal power module includes internal power source components (e.g., energy device(s), housing, compartment, etc.) along with one or more couplings and/or connectors appropriate to the internal power source. The Dot of an embodiment includes an internal power source comprising at least one of a power supply, transformer, and battery, but is not so limited.

The Dot of an embodiment includes at least one sensor configured to collect data and/or detect characteristics of the premises. The sensor includes but is not limited to at least one of a location sensor, tracking sensor, asset tracking sensor, light sensor, temperature sensor, acoustic sensor, environmental sensor, life safety sensor, carbon dioxide sensor, air quality sensor, and life style sensor. As an example, using provisioning as described in detail herein, the Dot including the light sensor can be configured for provisioning using a light-emitting device (e.g., laser pointer, etc.), where each Dot of an array is selected for provisioning by illuminating an area of the beacon with the light.

The Dot can be a stand-alone IOT device, as described in detail herein. Embodiments of this modularized IOT device can be implemented in various alternative form factors (e.g., tag, chip, band, clip, strap, badges, etc.). Further, a Dot can be a component of another system or subsystem component (e.g., lighting, security, home control, environmental control, audio/video, etc.). In other alternative embodiments, one or more Dot components can be included in one or more of the hardware and software of another system or subsystem (e.g., lighting, security, home control, environmental control, audio/video, etc.).

The Dot of an embodiment is configured to be a component of numerous devices with multiple different form factors, and/or couple and/or connect with devices with multiple different form factors. For example, a “Bolt Solo” is a surface-mount device configured to include the Dot. FIG. 2E is an isometric view of a Bolt Solo, under an embodiment.

An alternative device configuration comprising the Dot is referred to herein as the “Bolt” and is configured for mounting in the surface. Another alternative device configuration comprising the Dot is referred to herein as the “Snap” and is configured for mounting or “snapping” in a track (e.g., track component of a track lighting system). FIG. 2F shows the Bolt and Snap devices, under an embodiment. The Bolt includes two devices having different mounting configurations. In a first Bolt configuration (shown in FIG. 2F), the Bolt housing is configured to be inserted into a cutout in the surface and to be retained in the surface using one or more clips in an external region of the Bolt. A second Bolt configuration is configured to be screwed into a cutout in the surface and to be retained in the surface using threads on an external region of the Bolt. FIG. 2G is an isometric top view of a Bolt in the second configuration, under an embodiment. FIG. 2H is an alternative isometric top view of the Bolt in the second configuration, under an embodiment.

In another alternative embodiment, components and/or functionality of the Dot are included in IOT devices configured for integration into original equipment manufacturer (OEM) systems or devices, thereby configuring the OEM systems or devices as PPTS-enabled. More specifically, components of the Dot as described herein are included in IOT devices configured for integration into original equipment manufacturer (OEM) light fixtures. An example of such a device is the Dash device comprising Dot-like functionality in the PPTS and configured for integration into OEM troffer lights. FIG. 2I is an isometric view of a Dash device (left) configured for integration into an OEM troffer light (right), under an embodiment. Another example of such a device is the Cube device comprising Dot-like functionality in the PPTS and configured for integration into OEM down lights. FIG. 2J is an isometric view of a Cube device (left) configured for integration into an OEM down light (right), under an embodiment. The Dash and Cube devices, like the Dot, are available from Xenio System, San Francisco, Calif.

Dots of the Dot fabric or array are configured to communicate with the cloud platform. The cloud platform includes one or more devices comprising at least one processor coupled to at least one memory including one or more databases. The platform one or more of includes and is coupled to at least one application (referred to herein as the “platform program”) configured for communications including communications via the gateway with the Dots of the Dot array. The platform is also configured for communications with the mobile devices in the premises via one or more of the Dot array and alternative communication couplings or channels (e.g., broadband channels, WiFi, cellular channels, etc.). The platform program is configured to use data of these communications to detect presence and track real-time position of the mobile devices present in the premises.

It is understood that one or more of the components, devices, and/or functionality described herein with respect to the platform can be distributed between the platform and the gateway. In particular, any description herein to data received, data stored, and/or processing performed is understood as being performed at the platform, the gateway, the beacon, and/or distributed between any of the platform, gateway, and beacon.

The platform program is configured to detect the presence and track the real-time position of each mobile device using data of signals received from one or more of the mobile device and Dots of the Dot array. The mobile device, which is configured to include the retailer app with the PPTS component, communicates with the Dots and the platform program. The data of signals received from the mobile device includes signal strength data and data from the retailer app. Alternatively, each mobile device can provide to the platform program position data representing the real-time position of the mobile device.

As described herein, beacon fabric installation involves each Dot being installed in a premises or area of a premises and coupled or connected to a local gateway via a wired (e.g., CATS, Ethernet cable, etc.) and/or wireless channel and a power switch. Following installation of the Dots in the premises, the Dots are provisioned. Embodiments of provisioning generally include a provisioning application or “provisioning app” hosted on a portable computer (e.g., tablet computer, smart phone, personal computer (PC), etc.) (“provisioning device”). A “provisioning” mode is selected using a user interface (UI) of the provisioning app. In provisioning mode, the cloud platform and/or gateway selectively controls a state of each Dot of the array into the provisioning mode, and the visual indicator of a Dot in the provisioning mode is configured to provide an indication related to the provisioning. The indication in an embodiment includes illumination (e.g., steady illumination, alternate off/on, blinking with a pattern, etc.), but is not so limited.

The platform program is configured to control the Dot array and configuration of the Dots and Dot array. This control includes the provisioning of the Dot array. The provisioning generally comprises associating a logical address of each Dot in the array with a physical location of that Dot, as described in detail herein. In so doing, the platform program uses logical and physical data of the Dots. The logical data includes logical addresses of the communication devices of the Dots. The physical data includes physical location data of the Dots. Thus, because the Dots are cloud-managed, the radio (Bluetooth) identification data (ID) (e.g., UDID, major ID, minor ID, etc.) of the Dots of an array can be changed simultaneously from a cloud user interface or application.

The platform program includes a physical layout or schematic of the Dot array along with a list of Dots in the array. The provisioning of an embodiment is configured to associate the physical location of a Dot in the array according to this schematic with a logical address or identification of the Dot. So, upon identifying a physical location of a Dot during provisioning, the platform program assigns a logical address to the identified Dot, and concludes provisioning for the particular Dot.

More particularly, the provisioning involves communications of the Dot with the provisioning device and with the platform program. The provisioning device includes a portable computing device (e.g., smart phone, tablet computer, portable computer, etc.) running the provisioning app, as described in detail herein. The provisioning comprises communications via a first channel between the provisioning device at the premises and the Dot(s), and communications via a second channel between the provisioning device and the platform program.

A Dot in the provisioning mode is configured to detect or sense the provisioning app via communication with the provisioning device. The communication of an embodiment includes communication with the Dot communication device or radio (e.g., Bluetooth radio) via a channel between the provisioning device and the Dot. As the provisioning device comes in close proximity to a Dot and is detected, the visual indicator of that Dot visually indicates detection of the provisioning device. The visual indication, which signals an operator of the provisioning device that a particular Dot is selected for provisioning, includes changing the illumination state from that used to indicate the beacon is in the provisioning mode to some different state (e.g., change color, start flashing, become steady from a flashing state, flash with a different pattern, etc.).

Using communication with the provisioning app, the cloud platform is configured to determine the correspondence between a physical location of a particular Dot of the Dot array adjacent the provisioning device and the logical address of that corresponding Dot. The cloud platform determines a physical position of a Dot in the array using signal strength on the communication channel between that Dot and the provisioning device. Therefore, the provisioning device is configured to identify its position adjacent to a closest Dot using relative strength of signal, and therefore identify the particular Dot as one “selected” for provisioning based on proximity to the app. Upon identification of a Dot and determination of a physical location of the Dot, the cloud platform associates physical location of that Dot with a logical address of the Dot in the array. Following association of the physical and logical addresses of the Dot, and assignment of an identification (ID) to the Dot, the visual indicator state changes from illuminated to another state (e.g., dim, off, different color, etc.).

Following provisioning of each Dot, the provisioning process continues when the provisioning device is relocated proximate to another Dot (unprovisioned) in the array. This provisioning process continues sequentially as described herein until all Dots in the array have been provisioned.

Once provisioned, the Dot array is configured to determine the location of individuals in the environment having smart phones or other portable computing devices with the corresponding facility or retailer app. An embodiment uses signal strength to determine a location of the mobile device in the environment but is not so limited. Each Dot of the array is configured to communicate with the mobile device via the Dot radio (e.g., Bluetooth, etc.), and the system then uses received signal strength of each radio communication to determine an approximate position of each individual in the environment as the position of that particular beacon.

The cloud platform includes a rules engine, which in an embodiment is a component of the platform program. The rules engine is configured to operate using at least the presence and/or position information of on-site consumers. Using the position information of a consumer, for example, the cloud platform can generate and send particular messages or push information to the retailer app of the mobile device of that consumer. The retailer app generates a display or presentation of the information on the mobile device. For example, the PPTS determines the consumer is located adjacent the merchandise of Acme Corporation. In response, a message including an offer relating to Acme Corporation (e.g., “10% off all Acme Corporation merchandise”) is transmitted to the consumer via the retailer app. As another example, the PPTS determines the consumer has returned for a second time to a location adjacent the merchandise of Acme Corporation and, in response, sends a message including an offer relating to Acme Corporation (e.g., “15% off Acme Corporation shoes”) is transmitted to the consumer via the retailer app.

Content of the messages is related to an item(s) adjacent the real-time position of the corresponding mobile device. The content includes a request icon configured to send to the platform program, upon activation, an electronic request relating to the adjacent item(s). The electronic request can include a request for assistance with the adjacent item(s), for example, a request to dispatch a consumer support representative to the real-time position. Alternatively, the request for assistance comprises a request to receive electronic assistance in real-time. The electronic assistance includes assistance via one or more of telephone, instant message, electronic chat, and electronic mail, but is not so limited. The electronic request also may include a request to receive information of the at least one item. The content of the messages also includes directions relating to a position of another item different from or related to the adjacent item(s), and the directions include navigation instructions to a position of the other item from the real-time position.

The platform is configured to couple to and/or include account data of a user of a corresponding mobile device, and the account data includes but is not limited to account data of one or more retailers hosting the PPTS and/or related retailers or organizations. For example, the platform of an embodiment is configured to include an application programmer interface (API) configured to couple or communicate with retailer servers including point-of-sale (POS) systems. Similarly, the platform of an embodiment is configured to include an application programmer interface (API) configured to couple or communicate with social media system servers (e.g., Facebook, Twitter, Instagram, etc.), for example, or to otherwise couple to and/or include social media data of a user of a corresponding mobile device. Using one or more of the account data and social media data, the platform program is configured to generate messages to a mobile device. Furthermore, the platform program is configured to detect behavioral characteristics of a consumer from data of the presence and the real-time position of the mobile device.

The platform program is configured to generate a database of the presence data of the detected presence and position data of the tracking. Furthermore, the platform program includes a reporting component configured to output report(s) characterizing data gathered and stored in the database. For example, the cloud platform of an embodiment is configured to generate reports to retailers of consumer traffic for a period of time (e.g., numbers of consumers, consumer traffic, locations frequented, return trips to a location(s), etc.). Similarly, the cloud platform is configured to generate reports to consumers of outlets visited and related information.

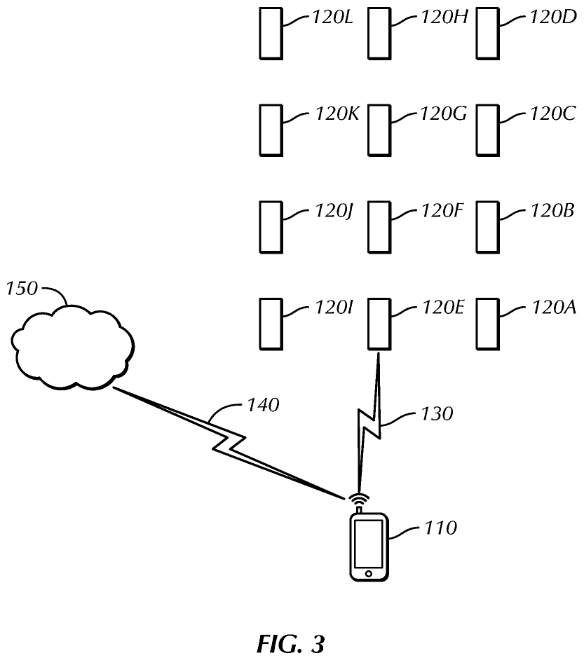

As described in detail herein, installation of the PPTS fabric involves each Dot being installed in a premises or area of a premises. Following physical installation of the Dot array in the premises, the Dots are provisioned. FIG. 3 is shows a mobile device 110 establishing or provisioning a group of deployed devices 120A, . . . , 120L positioned in a regular pattern and communicating with a computer network 150, under an embodiment. Mobile device 110, which is configured as the provisioning device including the provisioning app (stand-alone or integrated in associate app), is portable and can be a smart phone or other portable or mobile device that is carried by a user. The deployed devices include Dots as described herein. However, deployed devices 120A, . . . , 120L that are being established can be any group of devices that need to be established with an address. For example, deployed devices 120A, . . . , 120L can be light assemblies, sensors, speakers, etc. In one alternative embodiment, deployed devices 120A, . . . , 120L are light assemblies with light sources that have been configured to be smart lighting modules that can communicate and connect with other devices. Computer network 150 includes the cloud device or platform, and is configured to include one or more computers with memory that communicate with other computers and/or external devices. Provisioning device 110 communicates with deployed devices 120A, . . . , 120L by sending and receiving wireless signals 130 between them. Wireless signals 130 can be radio signals, Bluetooth signals, visible light signals, non-visible light signals, and/or sound waves. Provisioning device 110 also communicates with cloud device 150 by sending and receiving wireless signals and/or wired signals 140 between them.

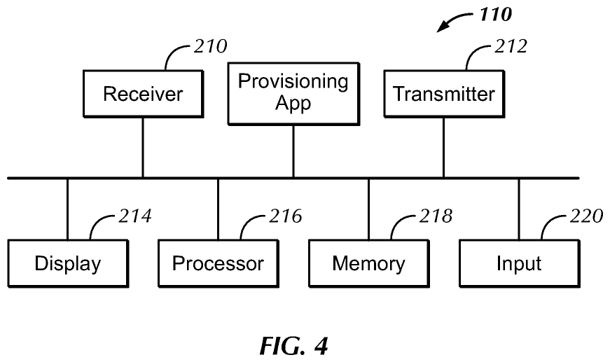

FIG. 4 is a block diagram of a provisioning device 110 configured as a provisioning device to establish the Dots 120A, . . . , 120L, under an embodiment. Provisioning device 110 includes the provisioning app as described herein and, additionally, a receiver 210, a transmitter 212, a display 214, a processor 216, a memory 218, and an input 220. The provisioning app is configured for over-the-air (OTA) download from a server or other processing device, but is not so limited. Receiver 210 and transmitter 212 are used to receive and transmit signals, respectively and can include the same or different antennas. Display 214 can be a touch screen or other display as used with mobile smart phone devices. Processor 216 and memory 218 are used to process information and send it out through transmitter 210. Input 220 can be incorporated into display 214 or can be standalone input device such as a keypad or keyboard.

Receiver 210 of provisioning device 110 receives an incoming signal 130 from at least one of the Dots 120A, . . . , 120L. The provisioning app is executed by the processor 216 such that processor 216 analyzes all incoming signals received from the Dots 120A, . . . , 120L to determine which of the Dots is nearest to provisioning device 110. Transmitter 212 sends an outgoing signal to the nearest of the Dots, which is illustrated as Dot 120E. The Dot 120E is a Dot, but in some embodiments the Dots 120A, . . . , 120L are other devices including the Dot and/or Dot components in one or more of the hardware and software of the device (e.g., lighting, sensors, security, home control, environmental control, audio/video, etc.). The outgoing signal can be a radio signal. The outgoing signal that is transmitted by provisioning device 110 can provide information to establish the Dots 120A, . . . , 120L. The information in the outgoing signal can be used to establish the Dot that is nearest to provisioning device 110 at that time. Provisioning device 110 uses processor 216 and memory 218 to analyze the incoming signals to determine which of the Dots 120A, . . . , 120L is nearest to provisioning device 110 by comparing all the incoming signal strengths received from all the Dots 120A, . . . , 120L and associating the distance from provisioning device 110 to the Dots 120A, . . . , 120L according to incoming signal strength. The incoming signal can include a unique device identifier of each of the Dots 120A, . . . , 120L. The outgoing signal from the transmitter 212 can provide an address such as a logical address, a tag, a network address, a location string or other means of addressing.

Provisioning device 110 of an embodiment is configured to transmit a second outgoing signal 140 to another computer, which can be a network computer 150 located on the cloud, located on or off the premises, etc. The second outgoing signal 140 can be used by provisioning device 110 to communicate to the network computer 150 information about the Dot 120A, . . . , 120L, which is being established, such as the unique identifier and the address provided to the Dot.

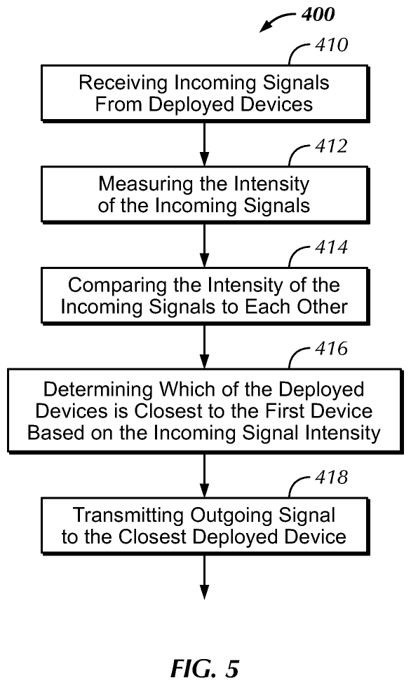

FIG. 5 is a flow diagram 400 for using a provisioning device 110 to establish Dots 120A, . . . , 120L, under an embodiment. The provisioning, as described herein, establishes the Dots with an address that configures them to connect and communicate with a computer network 150, under an embodiment. In operation 410, provisioning device 110 receives an incoming signal from at least one of the Dots 120A, . . . , 120L. The incoming signal can include a unique device identifier of each of the Dots 120A, . . . , 120L. In operation 412, the intensity of the incoming signal is measured. In operation 414, the measured intensities of all the incoming signals from the various Dots 120A, . . . , 120L are compared to each other.

In operation 416, the Dot nearest to the provisioning device 110 is determined based on the incoming signal strength. This can be done by associating the distance of the Dots 120A, . . . , 120L from the provisioning device with the incoming signal strength so that the strongest incoming signal strength is associated as being nearer (shorter distance) and the weakest incoming signal strength is associated as being further away (longer distance). In operation 418, the provisioning device 110 transmits an outgoing signal to the nearest Dot. The outgoing signal can include information to establish the nearest of the Dots. For example, the outgoing signal can include an address such as a logical address, a tag, a network address, a location string or other means of addressing. The outgoing signal can be a radio signal.

The method can further include transmitting a second outgoing signal to another computer, which can be a network computer 150 located on the premises or off the premises. The second outgoing signal can be used by the provisioning device to communicate to the network computer 150 information about the Dot 120A, . . . , 120L, which is being established, such as the unique identifier and the address provided to the Dot.

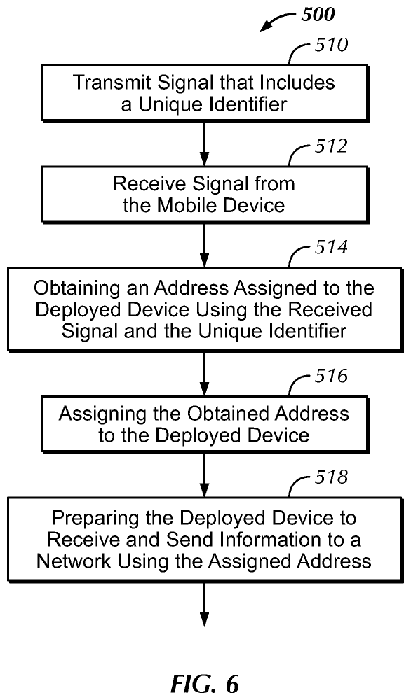

FIG. 6 is a flow diagram 500 for one or more of the Dots 120A, . . . , 120L to receive an address and become established to connect and communicate with a network, under an embodiment. In operation 510, a Dot 120 transmits an outgoing signal that includes a unique device identifier for itself. In operation 512, Dot 120 receives an incoming signal that includes an address from provisioning device 110. In operation 514, Dot 120 processes the incoming signal to determine and obtain the address. The address assigned to the Dot is obtained using the received signal and the unique identifier. The obtained address can be a logical address, a network address, a location string or a tag. In operation 516, the obtained addressed is assigned to the Dot 120. The outgoing signal can include more information than the unique identifier of the device. Similarly, the incoming signal can include more information than the address to be assigned to the device with the unique identifier. The incoming and outgoing signals can be radio signals. In operation 518, Dot 120 is prepared for to receive and send information to a computer network using the assigned address.

The PPTS thus enables brick-and-mortar storefronts and other physical facilities with capabilities similar to those of online retailers. Online retailers have capabilities including tracking consumer traffic and behavior, merchandise/pages viewed by a consumer, and length of time spent on a page, merchandise description, and/or site, to name a few. The PPTS is configured to provide similar capabilities in the store environment including identifying the presence of VIP customers, tracking consumer behavior using information of their location, merchandise viewed, areas of the store visited, and length of time spent in a particular area, in the vicinity of particular merchandise, and/or in the retail outlet. Furthermore, because consumer location is accurately known in the outlet, the PPTS is configured to offer access to real-time concierge services via their retailer app. To that end, a consumer needing help is enabled with a selectable icon (e.g., Concierge Button™, etc.) on the retailer app, the selection of which summons a consumer service representative to their location in the retail outlet. Additionally, consumers can receive turn-by-turn directions to merchandise in the retail outlet.

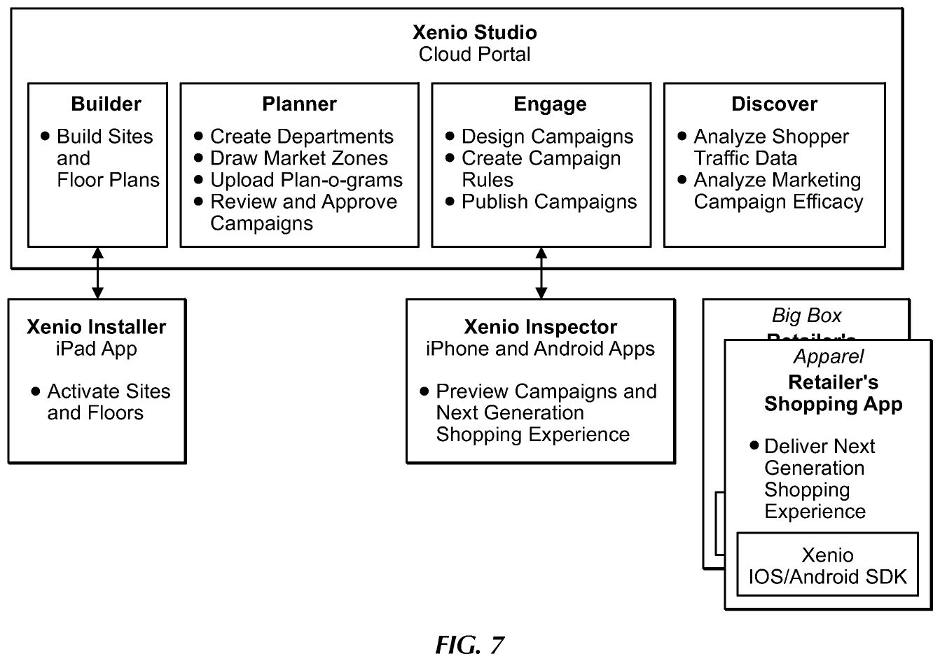

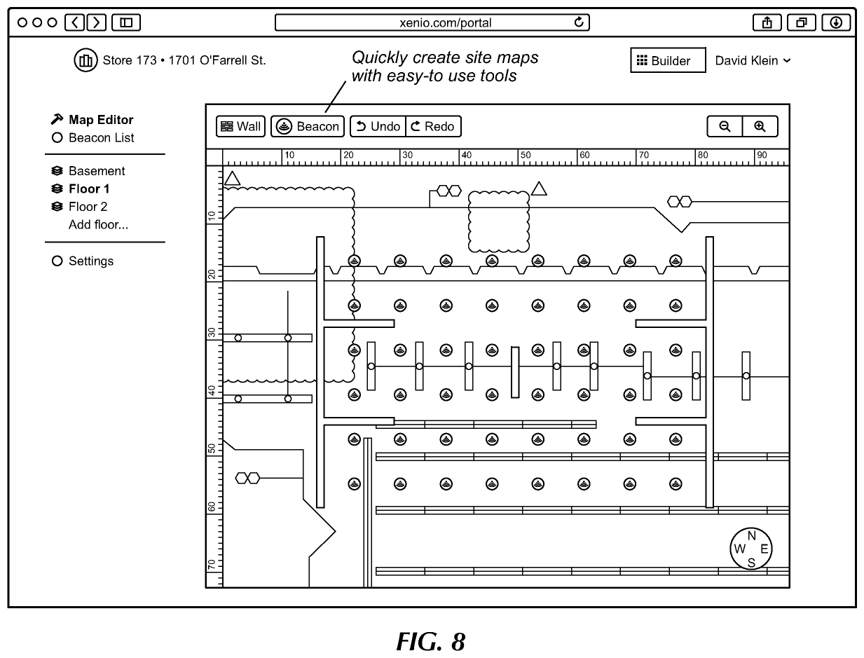

FIG. 7 is a block diagram of the cloud-based platform program, under an embodiment. The cloud platform is coupled to the device array, and includes the platform program as described in detail herein. The platform program is configured to use device array data from the devices of the device array and mobile device data from the mobile application to detect presence and track real-time position of the mobile devices in the premises, and provide related content of the premises to visitors and associates corresponding to the premises. The platform program is configured to detect the presence and track the real-time position of each mobile device using the mobile device data received from the mobile application, and the mobile device data includes signal strength data that represents communications between the mobile application and one or more devices of the device array.

The platform program is configured to receive data corresponding to the premises and generate content representing or using the data. The data corresponding to the premises includes but is not limited to floor plan data, plan-o-grams, merchandise maps, plans comprising locations of products in the premises, and/or plans comprising locations of services in the premises. The mobile application, as described herein, is configured to run on one or more mobile devices and exchange the data with the platform program, and receive and display the content in real-time at the mobile device by generating a user interface at the mobile device. The user interface is configured to display the content, and includes a number of controls or icons configured to receive the data via input data received at the user interface of the host mobile device.

Similarly, the associate application, as described herein, is configured to run on one or more associate devices and exchange the data with the platform program, and receive and display the content in real-time at the associate device by generating a user interface at the host associate device. The user interface is configured to display the content, and includes a number of controls or icons configured to receive the data via input data received at the user interface of the host associate device.

The platform program or suite is configured to include a builder component. The builder component is configured to communicate with an installer application or app regarding premises site activation. The installer application of an embodiment is a component of the associate app or includes a separate app configured for execution on the associate device. The builder component is configured to generate a floor plan or site map of the premises using one or more of data corresponding to the premises and data received or inputted at the associate device. FIG. 8 is an example site map of the platform program, under an embodiment. The floor plan includes a map of an interior region of the premises, and includes positions of the premises beacons relative to the interior region. The floor plan of an embodiment is a component of the content rendered at the associate devices and/or the mobile devices.

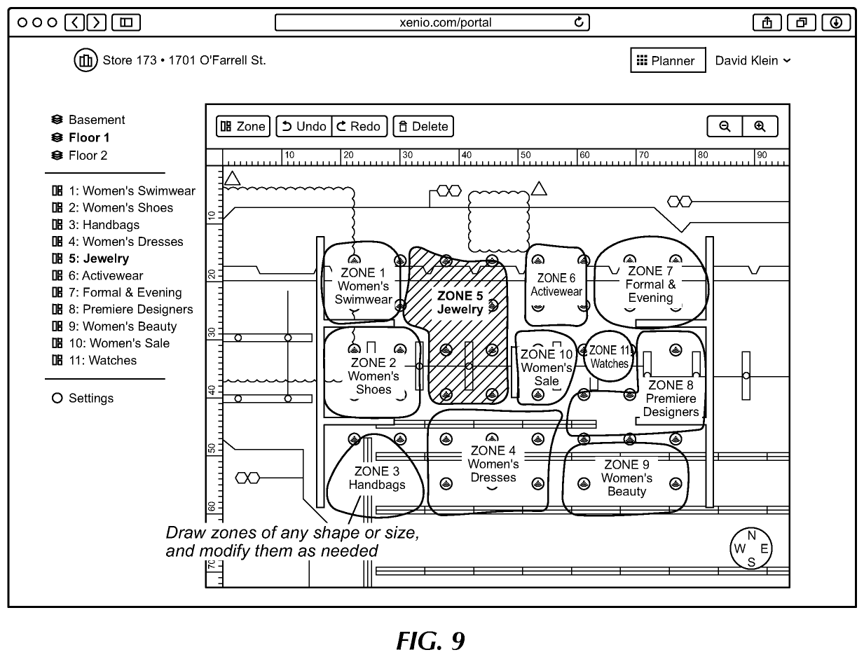

The platform program is also configured to include a planner component. The planner component is configured to generate or demarcate a number of zones in the premises using one or more of the data of the premises and data received or inputted at the associate device. FIG. 9 is an example zone map of the platform program, under an embodiment. The zones, which are reconfigurable, include one or more of marketing zones corresponding to activities of the premises, and departments corresponding to activities of the premises. The planner component is configured to access campaigns corresponding to the zones, and the data corresponding to the premises includes campaign data corresponding to the campaigns. The zones and campaign data are components of the content rendered at the associate devices and/or the mobile devices.

The platform program is further configured to include an engage component configured to generate, from one or more of data corresponding to the premises and data received or inputted at the associate device, campaigns corresponding to activities of the premises, and corresponding campaign rules and notifications. The engage component is configured to communicate with an inspector application or app to preview campaigns and campaign data. The inspector application of an embodiment is a component of the associate application or includes a separate application configured for execution on the associate device.

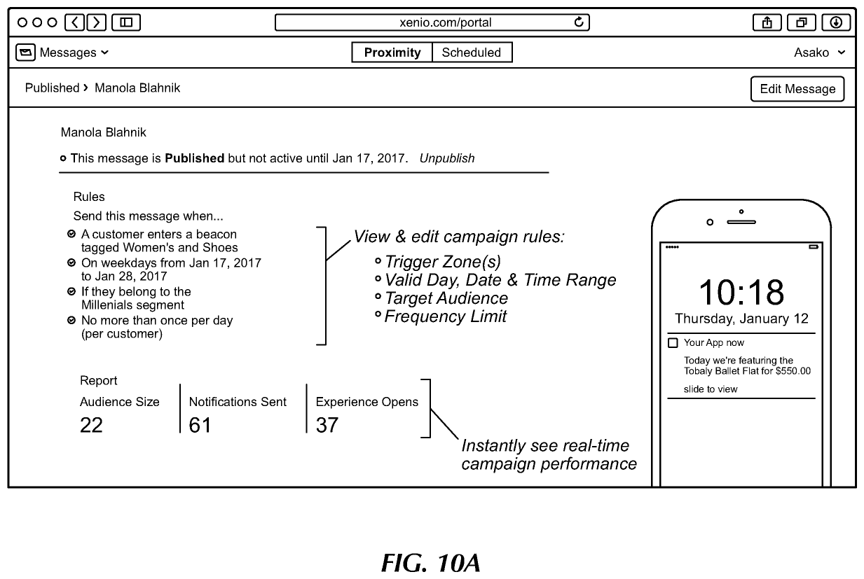

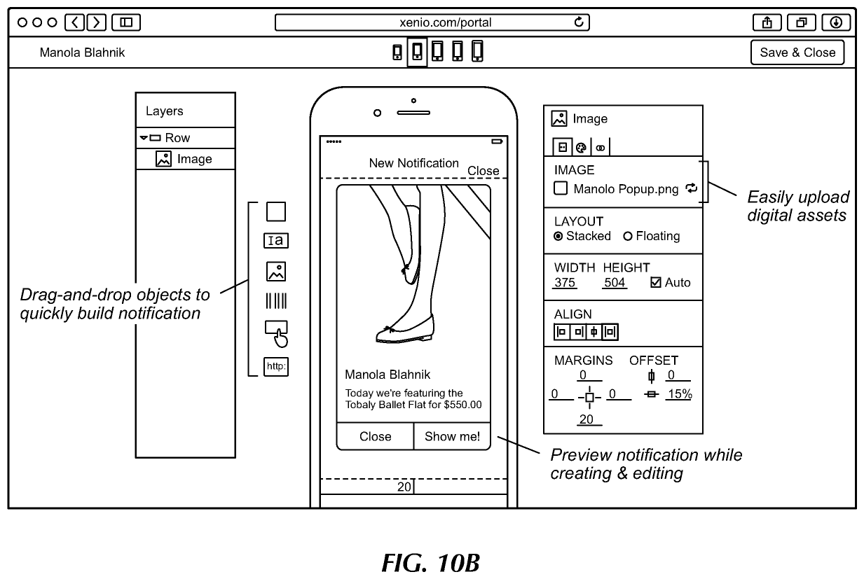

FIG. 10A is an example of campaign generation of the platform program, under an embodiment. FIG. 10B is an example of campaign notification generation of the platform program, under an embodiment. The campaign rules of an embodiment include but are not limited to one or more of trigger zones, identification data for a target audience, a frequency limit, a day, a range of days, a calendar date, a range of calendar dates, a time, a duration, and a time range. The engage component is configured to publish the campaigns, and generate campaign data including performance data. The performance data is generated using at least one of the device array data from the beacon devices and the mobile device data from the mobile applications of the mobile devices. The campaigns and campaign rules are components of the content rendered at the associate devices and/or the mobile devices, but are not so limited.

The platform program of an embodiment includes a discover component configured to generate analytical data relating to the premises and activities of the premises. The analytical data is generated using, for example, the mobile device data from the mobile applications of the mobile devices, but is not so limited. The analytical data and products or outputs from processing of the analytical data are components of the content rendered at the associate devices and/or the mobile devices.

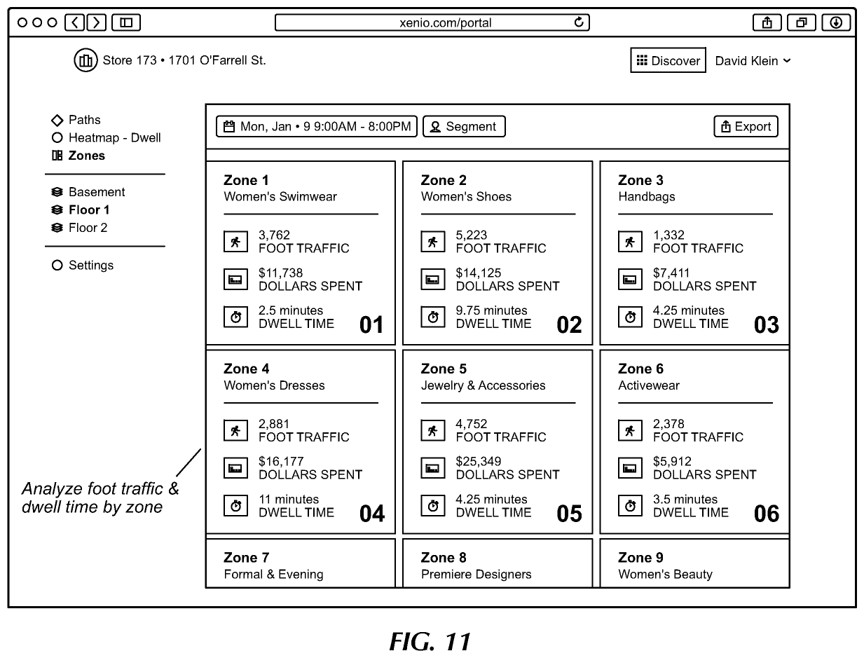

The discover component is coupled to and/or includes one or more filters and/or processing operations or routines configured for application to the analytical data. The analytical data generated includes one or more of heat maps, activity movies, maps including real-time traffic data, numbers of mobile devices according to premises region visited, and dwell time of the mobile devices according to a region of the premises, to name a few. FIG. 11 is an example analytical data presentation of the platform program analytical data, under an embodiment.

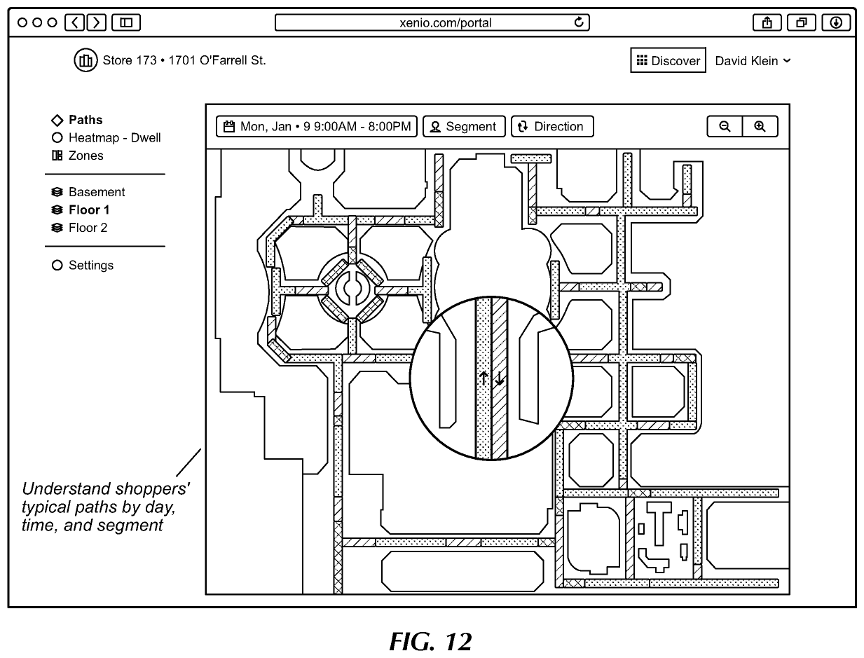

The real-time traffic data comprises path data including paths traversed in the premises by detected mobile devices. The path data also includes one or more of velocity data of the mobile devices at the premises, and congestion data of a number of the mobile devices represented in the path data. The path data is mapped according to one or more of a period of time, a day, and a region of the premises, for example. The path data is also mapped according to data of at least one owner corresponding to at least one mobile device, and the owner data includes profile data, age, demographic data, geographic data, psychographic data, and/or account data of at least one entity corresponding to the owner. FIG. 12 is an example traffic map of the platform program analytical data, under an embodiment.

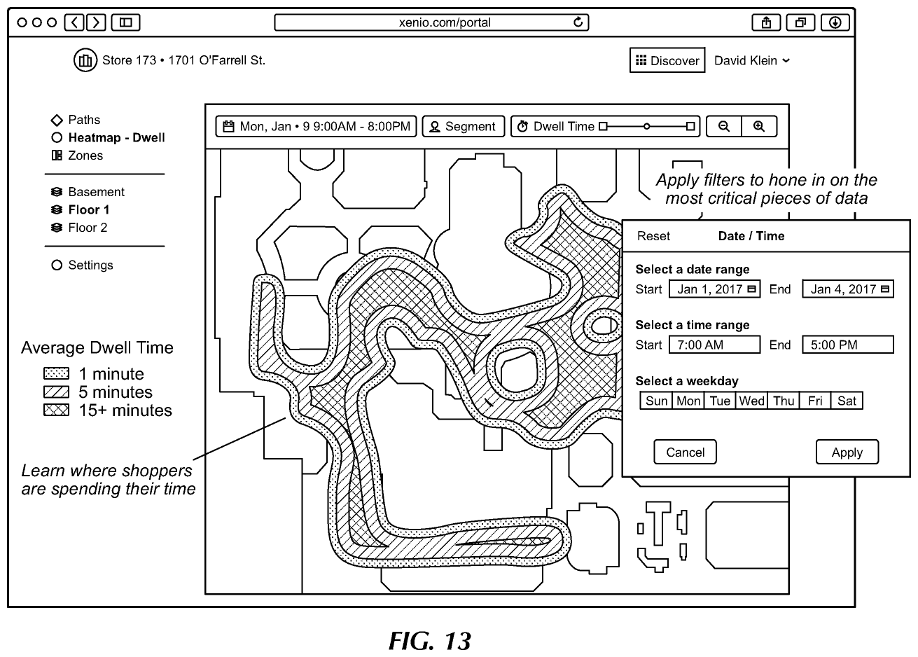

The analytical data includes traffic data of traffic at the premises, and marketing campaign efficacy data of campaigns corresponding to activities of the premises, as described herein. The platform program is configured to generate heat maps comprising a graphical representation of the traffic data using a number of cells displayed on a map of the premises, and each cell has a size and color corresponding to the traffic data during a pre-specified period of time. FIG. 13 is an example heat map of the platform program analytical data, under an embodiment. The platform program of an embodiment is further configured to generate an activity movie comprising a time-lapse graphical representation of the traffic data during a pre-specified period of time.

The PPTS embodiments are configured to enable retailers to generate and automatically provide to consumers via their mobile devices contextual engagement information or data comprising notifications, directions, alerts and/or various other information pertaining to the premises and activities or operations at the premises. Using an example in which the premises is a retailer or retail outlet, the PPTS is configured to generate and automatically provide to consumers or shoppers content including messages, incentives, advertisements and the like relating to the retailer. The incentives (e.g., discounts, perks, coupons, free goods and/or services, etc.) include incentives to entice the consumers to download and use the retailer's app, which includes as a component the mobile application. The retailer app and/or mobile application is configured for consumers to create a personal profile including personal information along with information describing particular interests relating to the type of goods offered by the retailer. The profile information, and/or other account or social media information, is integrated or used by the platform program along with real-time location information when the consumer is in the retailer premises to implement promotional campaigns, incentives and other information for delivery to the consumer in real-time when onsite at the premises. Furthermore, the location information of the consumer can be archived along with their account and/or profile information for use in analyzing merchandise in which the consumer is typically interested.

The platform program is configured to receive data corresponding to the premises and generate content or messages representing or using the data, as described herein. As described, the content generated and delivered includes messages and information configured for contextual engagement of a user of a mobile device detected at the premises. The content includes, for example, contextual engagement information comprising one or more icons configured to, upon selection, present additional data corresponding to the premises. The platform program selectively generates and delivers the content or messages to each mobile device in real-time based on profile and/or location data (in the premises) of the mobile device owner. The message or content and the real-time message delivery are also based on one or more of real-time or historical position data of the target mobile devices in the premises, and account data of the mobile device owner including one or more of a retailer account and a service provider account, but not so limited.

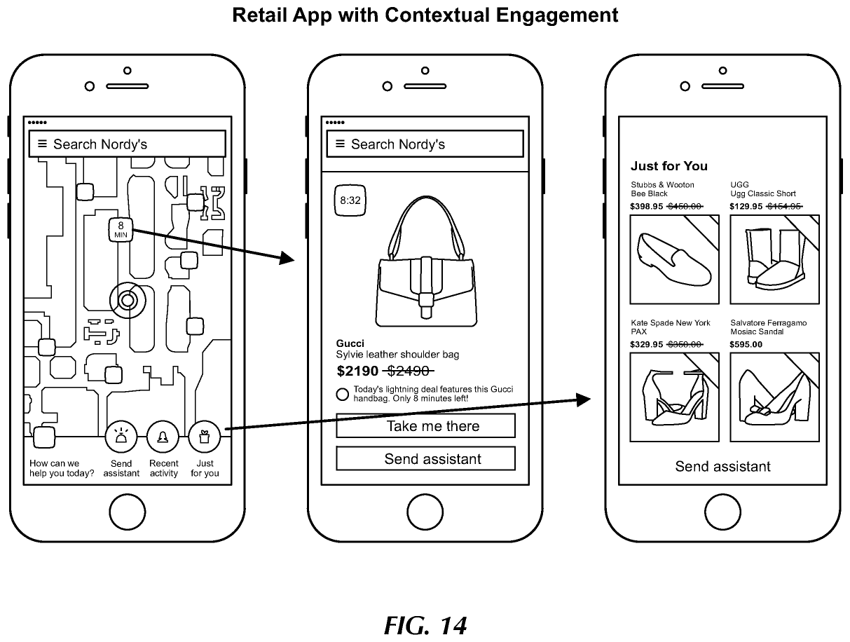

FIG. 14 is an example user interface presented by the mobile application and configured to provide contextual engagement information relating to the premises, under an embodiment. The icons presented as components of the interface include icons configured to, upon selection, present content including at least one of a search control, directions within the premises, item descriptions, and temporary events (e.g., sales, etc.) occurring at the premises. The directions, which include directions relating to a position of one or more items in the premises, comprise a route depicted on a map of the premises and/or navigation instructions to the position from the real-time position, but are not so limited.

In this example interface, notification of a flash sale is provided with content that includes a sale icon presented on a map of the premises at the location at which the corresponding merchandise is found, and displaying an amount of time (e.g., “8 MIN”) remaining in the sale. The sale icon is configured, upon selection, to navigate to a merchandise page presenting detailed information (e.g., price, description, etc.) of the merchandise. The merchandise page also includes icons configured to, upon selection, cause navigation information or directions to the merchandise to be presented, and summon assistance by retailer personnel.

The content presented in this example also includes a “Just for you” icon. Selection of this icon navigates to a page on which is presented one or more items in which the user might be interested. The platform program selects items for presentation on this page based on correspondence to the current sale item, profile data, location information, and/or behavioral characteristics of the user, but is not so limited.

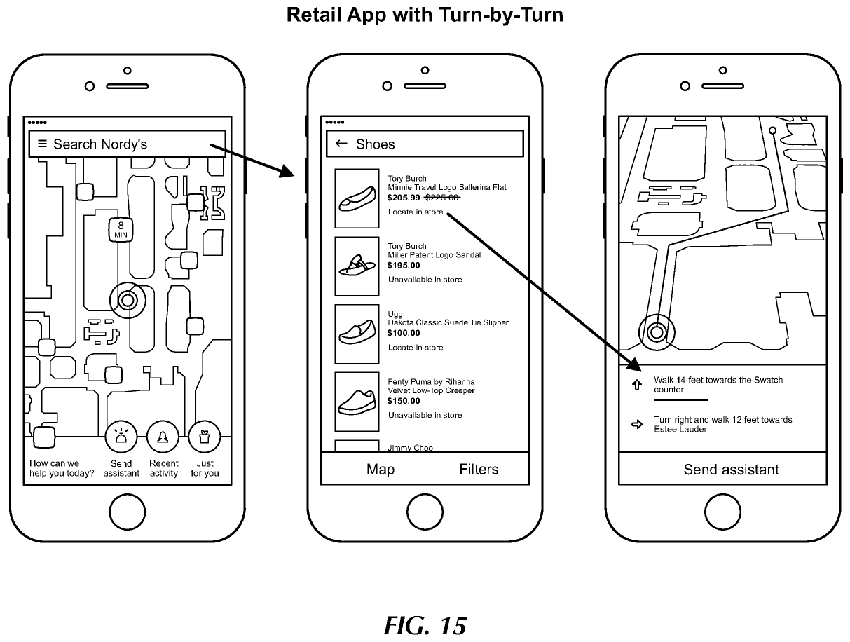

FIG. 15 is an example user interface presented on the mobile device and configured to provide contextual engagement information including item information corresponding to an item searched on via the interface, and turn-by-turn instructions to navigate to the item in the premises, under an embodiment. When information is entered into the interface search field, the platform program responds by presenting via the interface search results including detailed information on items relating to the search term(s). Selection of an item in the search results initiates presentation of a map and/or turn-by-turn instructions for navigating to the selected item.

The content of the contextual engagement information includes content related to items available or offered at the premises. The platform program dynamically selects items for presentation based on, for example, item position relative to the real-time position of the mobile device and/or personal or profile data of the mobile device user. The profile data includes account data, purchase history, online search history, and/or online browsing history of the owner, but is not so limited. The content includes item data comprising one or more of an item description, an item location, and a link to the item description. The item data includes a map of at least a portion of the premises along with a location of the item. Additionally, the map includes a link to a detailed description of the item, including price information.

The platform program is further configured to dynamically select items for presentation based on behavioral characteristics of the mobile device user. The platform program is configured to determine the behavioral characteristics through processing or analysis of profile data, presence data, and/or position data (e.g., real-time position, previous position, loiter time corresponding to the position data, etc.), for example, but is not so limited

The content of the contextual engagement information also includes at least one icon configured to link to one or more additional items. The platform program is configured to select the additional items using the real-time position of the mobile device, a previous position transited in premises, an item previously visited in the premises, and/or an item previously purchased. Furthermore, the platform program is configured to select the additional items using profile data of an owner corresponding to the mobile device, where the profile data includes account data, purchase history, browsing history in the premises, online search history, and/or online browsing history of the owner, for example.

Embodiments include a concierge icon or button as described herein, so the content presented by the mobile application includes a request icon configured to provide the concierge service. When the concierge icon is selected at the mobile device interface, the mobile application generates and sends to the platform an electronic request for personal assistance at the current position of the mobile device. The request for personal assistance includes one or more of a request to dispatch a customer support representative to the real-time position, and a request to receive in real-time electronic assistance corresponding to item(s) at the real-time position. The electronic assistance includes one or more of a request to receive information of an item at a subsequent time, and a request for assistance via at least one of telephone, instant message, electronic chat, and electronic mail.

In response to selection or activation of the concierge icon, the platform program generates content to the requesting mobile device that includes a response message that is a response to the request for personal assistance. The platform program is configured to selectively deliver the message to a mobile device in real-time based on the position of the mobile device in the premises. The content can also include a map of a region of the premises, and the map includes a depiction of the real-time position of the requestor, but is not so limited. The content includes one or more icons configured to present or deliver, upon selection, additional data corresponding to the premises, a search control, directions within the premises, item descriptions, and/or temporary events occurring at the premises as described in detail herein.

In addition to the mobile devices of consumers, the PPTS includes a facility representative application or “associate application” hosted on one or more associate devices and configured for use by individuals operating or working at the premises. The platform program is configured to use device array data from the beacon devices and associate device data from the associate application to detect presence and track real-time associate position of the associate devices in the premises. The associate application is configured to generate a user interface at the host associate device, and the user interface is configured to receive and display content of the platform program in real-time. The associate device user interface includes controls configured to receive input data at the host associate device.

In response to selection of the concierge icon at a mobile device, the platform program generates and delivers to one or more associate devices content including an associate message. The associate message content directs a customer support representative to a real-time position of the requesting mobile device. In an embodiment the platform delivers the associate message to numerous associate devices. For example, the platform can send a broadcast message to all associate devices in the premises. Alternatively, the platform generates and delivers the associate message to one or more select associate devices nearest the position of the requestor.

Content sent to the associate device(s) includes an assist icon, and the associate application is configured to generate and send to the platform an electronic acceptance of the request for personal assistance in response to selection of the assist icon via the associate device interface. The content also includes a map of a region of the premises, and the map includes a depiction of the real-time position of the requestor. Furthermore, the map of an embodiment includes a depiction of the real-time associate position of the one or more associate devices in the premises.

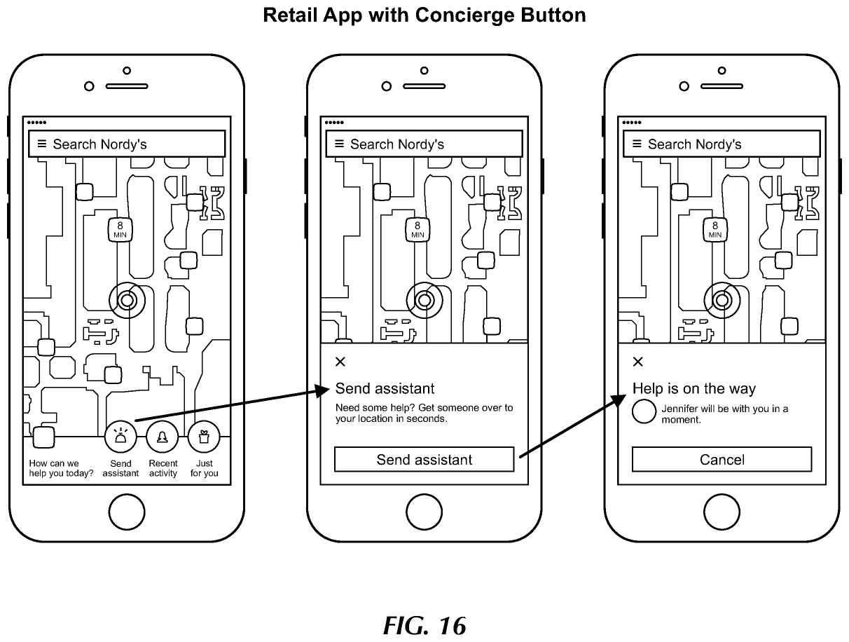

FIG. 16 is an example user interface presented on the mobile device and configured to provide a concierge icon or button, under an embodiment. In addition to the concierge icon, the information or icons presented as components of the interface include icons configured to, upon selection, present content including at least one of a search control, recent activity, and temporary events (e.g., sales, etc.) occurring at the premises. Selection of the concierge icon presents a request for assistance including a request button, the activation of which summons an associate of the retailer. The content presented at the requesting mobile device also includes a map of a region of the premises, and the map displays a position of the requestor. In an embodiment, the map additionally displays a position of the associate directed to assist the requestor following receipt of a request for assistance.

Embodiments include a system comprising a device array comprising a plurality of devices installed in a surface that forms a portion of a premises. Each device includes a communication device configured to communicate with a plurality of mobile devices at the premises. The system includes a cloud platform coupled to the device array via a remote network. The cloud platform is remote to the premises and includes a platform program configured to use device array data from the plurality of devices to detect presence and track real-time position of the plurality of mobile devices in the premises.

Embodiments include a system comprising: a device array comprising a plurality of devices installed in a surface that forms a portion of a premises, wherein each device includes a communication device configured to communicate with a plurality of mobile devices at the premises; and a cloud platform coupled to the device array via a remote network, wherein the cloud platform is remote to the premises and includes a platform program configured to use device array data from the plurality of devices to detect presence and track real-time position of the plurality of mobile devices in the premises.

The surface includes at least one of a ceiling and a ceiling component, wherein the ceiling component includes at least one of a tile, plank, panel, drop panel, grate, grid, beam, and support structure.

The system includes a gateway installed at the premises and coupled to the cloud device via the remote network, wherein the plurality of devices is coupled to the gateway.

The plurality of devices is coupled to the gateway using at least one of a wireless and a wired medium.

The system includes an external power source coupled to the plurality of devices of the device array and configured to supply power to the plurality of devices.

The external power source is coupled to the gateway.

The gateway includes the external power source.

The external power source comprises a Power-over-Ethernet device.

Each device includes an internal power supply coupled to the external power source.

The communication device includes a radio frequency (RF) communication device.

The communication device includes a Bluetooth device.

Each device comprises an internal antenna coupled to the communication device, wherein the internal antenna includes a Bluetooth Low Energy antenna.

Each device includes an antenna coupled to the communication device.

The antenna comprises a Bluetooth low energy antenna.

Each device includes a housing configured to contain the communication device and the antenna.

The housing is configured for mounting at least one of in and through the surface.

The housing includes a proximal end configured to be visible on the surface.

Each device includes circuitry coupled to the communication device, and an indicator coupled to the circuitry.

The indicator is positioned adjacent the proximal end, wherein the proximal end includes a translucent region adjacent the indicator.

The circuitry is configured to control a state of the indicator according to an operational state of the device, wherein the state of the indicator includes a first state corresponding to a first operational state of the device, and a second state corresponding to a second operational state of the device.

The indicator includes a visual indicator positioned adjacent to the proximal end of the housing.

The visual indicator includes a light-emitting diode (LED) with a plurality of illumination states, wherein the illumination states include at least one of illuminated, off, at least one illumination level, at least one color, and alternating between a first state and a second state.

The indicator includes an audible indicator positioned adjacent to the proximal end of the housing.

Each device includes an internal power supply coupled to the circuitry.

Each device includes a sensor coupled to the circuitry, wherein the sensor includes at least one of a location sensor, tracking sensor, asset tracking sensor, light sensor, temperature sensor, acoustic sensor, environmental sensor, life safety sensor, carbon dioxide sensor, air quality sensor, and life style sensor.

The mobile device includes at least one of a smart phone, a tablet computer, a smart watch, and a wearable computing device.

The platform program is configured to detect the presence and track the real-time position of each mobile device using data of signals received from the mobile device via the device array.

The data of signals received from the mobile device includes signal strength data.

The system includes an application configured to run on the plurality of mobile devices and communicate with the device array.

The application is a component of a third-party application.

The platform program is configured to detect the presence and track the real-time position of each mobile device using data from the mobile device application.

The plurality of devices of the device array are configured to receive the data from the mobile device application.

The platform program is configured to detect the presence and track the real-time position of each mobile device using data representing at least one device of the device array.

Instead of the platform program being configured to track the real-time position, each mobile device is configured to track and provide to the platform program data of the real-time position.

The platform program is configured to control the device array.

The platform program is configured to control a configuration of the plurality of devices of the device array.

The platform program includes at least one of logical data of the plurality of devices, logical addresses of the communication devices of the device array, and physical location data of the plurality of devices.

The platform program is configured to provision the device array.

The provisioning comprises associating a logical address of a device in the device array with a physical location of the device.

The provisioning comprises first communications via a first channel between a provisioning device at the premises and the plurality of devices.

The provisioning comprises second communications via a second channel between the provisioning device at the premises and the platform program.

The system includes a provisioning application configured to run on the provisioning device and to perform the first communications and the second communications.

The provisioning device includes at least one of a smart phone, a tablet computer, a smart watch, and a wearable computing device.

The platform program generates a database of at least one of presence data of the detected presence and position data of the tracking, wherein the platform program is configured to output at least one report characterizing a set of data of the database.

The platform program includes a rules engine.

The platform program is configured to generate messages to the plurality of mobile devices by operating on at least one of the presence data and the position data with the rules engine.

The platform program is configured to selectively push the messages to the plurality of mobile devices in real-time based on the real-time positions of the plurality of mobile devices in the premises.

The platform program is configured to selectively generate in real-time a message to a mobile device based on the real-time position of that mobile device.

The platform program is configured to push in real-time the message to the mobile device using the real-time position of that mobile device.

The message is related to at least one item adjacent the real-time position.

The content includes a request icon, wherein the request icon is configured to send to the platform upon activation an electronic request relating to the at least one item.

The electronic request includes a request for assistance with the at least one item at the real-time position, wherein the request for assistance comprises at least one of a request to dispatch a customer support representative to the real-time position, and a request to receive electronic assistance in real-time, wherein the electronic assistance includes assistance via at least one of telephone, instant message, electronic chat, and electronic mail.

The electronic request includes a request to receive information of the at least one item.

The content includes at least one of directions relating to a position of the at least one item, and navigation instructions to a position of the at least one item from the real-time position.

The platform program is configured to generate the messages using at least one of profile data corresponding to a mobile device and account data corresponding to the mobile device, wherein the profile data and the account data correspond to a user of the mobile device.

The platform program is configured to detect at least one behavioral characteristic from data of the presence and the real-time position.

At least one behavioral characteristic is related to at least one item adjacent the real-time position.

At least one behavioral characteristic includes at least one behavioral characteristic of a user of a mobile device of the plurality of mobile device.

The premises includes at least one of a retail outlet, an office, warehouse, healthcare facility, entertainment venue, and transportation facility.

Embodiments include a system a method comprising forming a device array comprising a plurality of devices installed in a surface. The surface forms a portion of a premises. Each device includes a communication device configured to communicate with a plurality of mobile devices at the premises. The method includes configuring a cloud platform to communicate with the device array via a remote network. The cloud platform is remote to the premises and includes a platform program configured to use device array data from the plurality of devices to detect presence and track real-time position of the plurality of mobile devices in the premises.

Embodiments include a system a method comprising: forming a device array comprising a plurality of devices installed in a surface, wherein the surface forms a portion of a premises, wherein each device includes a communication device configured to communicate with a plurality of mobile devices at the premises; and configuring a cloud platform to communicate with the device array via a remote network, wherein the cloud platform is remote to the premises and includes a platform program configured to use device array data from the plurality of devices to detect presence and track real-time position of the plurality of mobile devices in the premises.

The surface includes a ceiling component, wherein the ceiling component includes at least one of a tile, plank, panel, drop panel, grate, grid, beam, and support structure.

The method comprises configuring a gateway at the premises to communicate with the cloud device via the remote network, wherein the plurality of devices is coupled to the gateway.

The method comprises coupling the plurality of devices to the gateway using at least one of a wireless and a wired medium.

The method comprises coupling an external power source to the plurality of devices of the device array and configuring the external power source to supply power to the plurality of devices.

The method comprises coupling the external power source to the gateway.

The method comprises configuring the external power source to include a Power-over-Ethernet device.

The method comprises configuring each device to include an internal power supply coupled to the external power source.

The communication device includes a radio frequency (RF) communication device.

The communication device includes a Bluetooth device.

The method comprises configuring each device to include an internal antenna coupled to the communication device, wherein the internal antenna includes a Bluetooth Low Energy antenna.

The method comprises configuring each device to include an antenna coupled to the communication device.

The antenna comprises a Bluetooth low energy antenna.

The method comprises configuring each device to include a housing configured to contain the communication device and the antenna.

The method comprises configuring the housing for mounting at least one of in and through the surface.

The method comprises configuring the housing to include a proximal end configured to be visible on the surface.

The method comprises configuring each device to include circuitry coupled to the communication device, and an indicator coupled to the circuitry.

The method comprises positioning the indicator adjacent the proximal end.

The method comprises configuring the proximal end to include a translucent region adjacent the indicator.

The method comprises configuring the circuitry to control a state of the indicator according to an operational state of the device.

The method comprises configuring the state of the indicator to include a first state corresponding to a first operational state of the device, and a second state corresponding to a second operational state of the device.

The method comprises configuring the indicator to include a visual indicator positioned adjacent to the proximal end of the housing.

The method comprises configuring the visual indicator to include a light-emitting diode (LED) with a plurality of illumination states.

The method comprises configuring the illumination states to include at least one of illuminated, off, at least one illumination level, at least one color, and alternating between a first state and a second state.

The method comprises configuring the indicator to include an audible indicator positioned adjacent to the proximal end of the housing.

The method comprises configuring each device to include an internal power supply coupled to the circuitry.

The method comprises configuring each device to include a sensor coupled to the circuitry.

The method comprises configuring the sensor to include at least one of a location sensor, tracking sensor, asset tracking sensor, light sensor, temperature sensor, acoustic sensor, environmental sensor, life safety sensor, carbon dioxide sensor, air quality sensor, and life style sensor.

The mobile device includes at least one of a smart phone, a tablet computer, a smart watch, and a wearable computing device.

The method comprises configuring the platform program to detect the presence and track the real-time position of each mobile device using data of signals received from the mobile device via the device array.

The data of signals received from the mobile device includes signal strength data.

The method comprises configuring an application to run on the plurality of mobile devices and communicate with the device array.

The application is a component of a third-party application.

The method comprises configuring the platform program to detect the presence and track the real-time position of each mobile device using data from the mobile device application.

The method comprises configuring the plurality of devices of the device array to receive the data from the mobile device application.

The method comprises configuring the platform program to detect the presence and track the real-time position of each mobile device using data representing at least one device of the device array.

Instead of the platform program being configured to track the real-time position, configuring each mobile device to track and provide to the platform program data of the real-time position.

The method comprises configuring the platform program to control the device array.

The method comprises configuring the platform program to control a configuration of the plurality of devices of the device array.

The method comprises configuring the platform program to include logical data of the plurality of devices.

The method comprises configuring the platform program to include logical addresses of the communication devices of the device array.

The method comprises configuring the platform program to include physical location data of the plurality of devices.

The method comprises configuring the platform program to provision the device array.

The method comprises configuring the provisioning to associate a logical address of a device in the device array with a physical location of the device.

The method comprises configuring the provisioning to include first communications via a first channel between a provisioning device at the premises and the plurality of devices.

The method comprises configuring the provisioning to include second communications via a second channel between the provisioning device at the premises and the platform program.

The method comprises configuring a provisioning application to run on the provisioning device and to perform the first communications and the second communications.

The provisioning device includes at least one of a smart phone, a tablet computer, a smart watch, and a wearable computing device.

The method comprises configuring the platform program to generate a database of at least one of presence data of the detected presence and position data of the tracking.

The method comprises configuring the platform program to output at least one report characterizing a set of data of the database.

The method comprises configuring the platform program to include a rules engine.

The method comprises configuring the platform program to generate messages to the plurality of mobile devices by operating on at least one of the presence data and the position data with the rules engine.

The method comprises configuring the platform program to selectively push the messages to the plurality of mobile devices in real-time based on the real-time positions of the plurality of mobile devices in the premises.

The method comprises configuring the platform program to selectively generate in real-time a message to a mobile device based on the real-time position of that mobile device.

The method comprises configuring the platform program to push in real-time the message to the mobile device using the real-time position of that mobile device.

The method comprises configuring content of the message to relate to at least one item adjacent the real-time position.

The method comprises configuring the content to include a request icon, and configuring the request icon to send to the platform upon activation an electronic request relating to the at least one item.

The method comprises configuring the electronic request to include a request for assistance with the at least one item at the real-time position.

The method comprises configuring the request for assistance to include a request to dispatch a customer support representative to the real-time position.

The method comprises configuring the request for assistance to include a request to receive electronic assistance in real-time, wherein the electronic assistance includes assistance via at least one of telephone, instant message, electronic chat, and electronic mail.

The method comprises configuring the electronic request to include a request to receive information of the at least one item.

The method comprises configuring the content to include directions relating to a position of the at least one item.

The method comprises configuring the content to include navigation instructions to a position of the at least one item from the real-time position.

The method comprises configuring the platform program to generate the messages using profile data corresponding to a mobile device.

The method comprises configuring the platform program to generate the messages using account data corresponding to the mobile device.

The method comprises configuring the profile data and the account data to correspond to a user of the mobile device.

The method comprises configuring the platform program to detect at least one behavioral characteristic from data of the presence and the real-time position.

The at least one behavioral characteristic is related to at least one item adjacent the real-time position.

The at least one behavioral characteristic includes at least one behavioral characteristic of a user of a mobile device of the plurality of mobile device.

The premises includes at least one of a retail outlet, an office, warehouse, healthcare facility, entertainment venue, and transportation facility.

Embodiments include a device comprising a processor coupled to a memory including a database. The device includes at least one application running on the processor and configured for communications including communication over a first channel with a plurality of devices of a device array in a remote premises and communication over a second channel with a plurality of mobile devices in the premises. The at least one application is configured to use data of the communications to detect presence and track real-time position of the plurality of mobile devices in the premises.

Embodiments include a device comprising: a processor coupled to a memory including a database; and at least one application running on the processor and configured for communications including communication over a first channel with a plurality of devices of a device array in a remote premises and communication over a second channel with a plurality of mobile devices in the premises, wherein the at least one application is configured to use data of the communications to detect presence and track real-time position of the plurality of mobile devices in the premises.

The at least one application includes a platform program configured to detect the presence and track the real-time position of each mobile device using data of signals received from the mobile device via the device array.

The data of signals received from the mobile device includes signal strength data.

The device includes an application configured to run on the plurality of mobile devices and communicate with the device array.

The application is a component of a third-party application.

The platform program is configured to detect the presence and track the real-time position of each mobile device using data from the mobile device application.

The plurality of devices of the device array is configured to receive the data from the mobile device application.

The platform program is configured to detect the presence and track the real-time position of each mobile device using data representing at least one device of the device array.

Instead of the platform program being configured to track the real-time position, each mobile device is configured to track and provide to the platform program data of the real-time position.

The platform program is configured to control the device array.

The platform program is configured to control a configuration of the plurality of devices of the device array.

The platform program includes at least one of logical data of the plurality of devices, logical addresses of the communication devices of the device array, and physical location data of the plurality of devices.

The platform program is configured to provision the device array.

The provisioning comprises associating a logical address of a device in the device array with a physical location of the device.

The provisioning comprises first communications via a first channel between a provisioning device at the premises and the plurality of devices.

The provisioning comprises second communications via a second channel between the provisioning device at the premises and the platform program.

The device includes a provisioning application configured to run on the provisioning device and to perform the first communications and the second communications.

The provisioning device includes at least one of a smart phone and a table computer.

The platform program generates a database of at least one of presence data of the detected presence and position data of the tracking.

The platform program is configured to output at least one report characterizing a set of data of the database.

The platform program includes a rules engine.

The platform program is configured to generate messages to the plurality of mobile devices by operating on at least one of the presence data and the position data with the rules engine.

The platform program is configured to selectively push the messages to the plurality of mobile devices in real-time based on the real-time positions of the plurality of mobile devices in the premises.

The platform program is configured to selectively generate in real-time a message to a mobile device based on the real-time position of that mobile device.

The platform program is configured to push in real-time the message to the mobile device using the real-time position of that mobile device.

Content of the message is related to at least one item adjacent the real-time position.

The content includes a request icon, wherein the request icon is configured to send to the platform upon activation an electronic request relating to the at least one item.

The electronic request includes a request for assistance with the at least one item at the real-time position.

The request for assistance comprises at least one of a request to dispatch a customer support representative to the real-time position and a request to receive electronic assistance in real-time, wherein the electronic assistance includes assistance via at least one of telephone, instant message, electronic chat, and electronic mail.

The electronic request includes a request to receive information of the at least one item.

The content includes at least one of directions relating to a position of the at least one item, and navigation instructions to a position of the at least one item from the real-time position.

The platform program is configured to generate the messages using at least one of profile data corresponding to a mobile device, and account data corresponding to the mobile device, wherein the profile data and the account data correspond to a user of the mobile device.

The platform program is configured to detect at least one behavioral characteristic from data of the presence and the real-time position.

The at least one behavioral characteristic is related to at least one item adjacent the real-time position.

The at least one behavioral characteristic includes at least one behavioral characteristic of a user of a mobile device of the plurality of mobile device.

The device includes a gateway installed at the premises and coupled to the processor via a remote network that includes the first channel, wherein the plurality of devices is coupled to the gateway.

The plurality of devices is coupled to the gateway using at least one of a wireless and a wired medium.

The device includes an external power source coupled to the plurality of devices of the device array and configured to supply power to the plurality of devices.

The external power source is coupled to the gateway.

The gateway includes the external power source.

The external power source comprises a Power-over-Ethernet device.

Each device includes an internal power supply coupled to the external power source.

Each device of the plurality of devices of the device array includes a housing including a communication device, and configured for installation in the premises.

The housing is configured for installation in a surface of the premises, wherein the surface includes at least one of a ceiling and a ceiling component, wherein the ceiling component includes at least one of a tile, plank, panel, drop panel, grate, grid, beam, and support structure.

The communication device includes a radio frequency (RF) communication device.

The communication device includes a Bluetooth device.

Each device comprises an internal antenna coupled to the communication device, wherein the internal antenna includes a Bluetooth Low Energy antenna.

Each device includes an antenna coupled to the communication device.

The antenna comprises a low energy antenna.

The housing is configured to contain the communication device and the antenna.

The housing is configured for mounting at least one of in and through the surface.

The housing includes a proximal end configured to be visible on the surface.

Each device includes circuitry coupled to the communication device, and an indicator coupled to the circuitry.

The indicator is positioned adjacent the proximal end, wherein the proximal end includes a translucent region adjacent the indicator.

The circuitry is configured to control a state of the indicator according to an operational state of the device, wherein the state of the indicator includes a first state corresponding to a first operational state of the device, and a second state corresponding to a second operational state of the device.

The indicator includes a visual indicator positioned adjacent to the proximal end of the housing, wherein the visual indicator includes a light-emitting diode (LED) with a plurality of illumination states, wherein the illumination states include at least one of illuminated, off, at least one illumination level, at least one color, and alternating between a first state and a second state.

The indicator includes an audible indicator positioned adjacent to the proximal end of the housing.

Each device includes an internal power supply coupled to the circuitry.

Each device includes a sensor coupled to the circuitry, wherein the sensor includes at least one of a location sensor, tracking sensor, asset tracking sensor, light sensor, temperature sensor, acoustic sensor, environmental sensor, life safety sensor, carbon dioxide sensor, air quality sensor, and life style sensor.

The mobile device includes at least one of a smart phone, a tablet computer, a smart watch, and a wearable computing device.

The premises includes at least one of a retail outlet, office, warehouse, healthcare facility, entertainment venue, transportation facility.

Embodiments include a method comprising establishing communication between a processor and a memory including a database. The method includes configuring at least one application running on the processor for communications including communication over a first channel with a plurality of devices of a device array in a remote premises and communication over a second channel with a plurality of mobile devices in the premises. The at least one application is configured to use data of the communications to detect presence and track real-time position of the plurality of mobile devices in the premises.

Embodiments include a method comprising: establishing communication between a processor and a memory including a database; and configuring at least one application running on the processor for communications including communication over a first channel with a plurality of devices of a device array in a remote premises and communication over a second channel with a plurality of mobile devices in the premises, wherein the at least one application is configured to use data of the communications to detect presence and track real-time position of the plurality of mobile devices in the premises.

The method includes configuring the at least one application to include a platform program configured to detect the presence and track the real-time position of each mobile device using data of signals received from the mobile device via the device array.

The data of signals received from the mobile device includes signal strength data.

The method includes an application to run on the plurality of mobile devices and communicate with the device array.

The application is a component of a third-party application.

The method includes configuring the platform program to detect the presence and track the real-time position of each mobile device using data from the mobile device application.

The method includes configuring the plurality of devices of the device array to receive the data from the mobile device application.

The method includes configuring the platform program to detect the presence and track the real-time position of each mobile device using data representing at least one device of the device array.

The method includes, instead of configuring the platform program to track the real-time position, configuring each mobile device to track and provide to the platform program data of the real-time position.

The method includes configuring the platform program to control the device array.

The method includes configuring the platform program to control a configuration of the plurality of devices of the device array.

The method includes configuring the platform program to include at least one of logical data of the plurality of devices, logical addresses of the communication devices of the device array, and physical location data of the plurality of devices.

The method includes configuring the platform program to provision the device array.

The method includes configuring the provisioning to include associating a logical address of a device in the device array with a physical location of the device.

The method includes configuring the provisioning to include first communications via a first channel between a provisioning device at the premises and the plurality of devices.

The method includes configuring the provisioning to include second communications via a second channel between the provisioning device at the premises and the platform program.

The method includes configuring a provisioning application to run on the provisioning device and to perform the first communications and the second communications.

The provisioning device includes at least one of a smart phone and a table computer.

The method includes configuring the platform program to generate a database of at least one of presence data of the detected presence and position data of the tracking.

The method includes configuring the platform program to output at least one report characterizing a set of data of the database.

The method includes configuring the platform program to include a rules engine.

The method includes configuring the platform program to generate messages to the plurality of mobile devices by operating on at least one of the presence data and the position data with the rules engine.

The method includes configuring the platform program to selectively push the messages to the plurality of mobile devices in real-time based on the real-time positions of the plurality of mobile devices in the premises.

The method includes configuring the platform program to selectively generate in real-time a message to a mobile device based on the real-time position of that mobile device.

The method includes configuring the platform program to push in real-time the message to the mobile device using the real-time position of that mobile device.

The method includes configuring content of the message to relate to at least one item adjacent the real-time position.

The method includes configuring the content to include a request icon, wherein the request icon is configured to send to the platform upon activation an electronic request relating to the at least one item.

The method includes configuring the electronic request to include a request for assistance with the at least one item at the real-time position.

The method includes configuring the request for assistance to include a request to dispatch a customer support representative to the real-time position.

The method includes configuring the request for assistance to include a request to receive electronic assistance in real-time, wherein the electronic assistance includes assistance via at least one of telephone, instant message, electronic chat, and electronic mail.

The method includes configuring the electronic request to include a request to receive information of the at least one item.

The method includes configuring the content to include at least one of directions relating to a position of the at least one item and navigation instructions to a position of the at least one item from the real-time position.

The method includes configuring the platform program to generate the messages using at least one of profile data corresponding to a mobile device and account data corresponding to the mobile device.

The profile data and the account data correspond to a user of the mobile device.

The method includes configuring the platform program to detect at least one behavioral characteristic from data of the presence and the real-time position.

The at least one behavioral characteristic is related to at least one item adjacent the real-time position.

The at least one behavioral characteristic includes at least one behavioral characteristic of a user of a mobile device of the plurality of mobile device.

The method includes coupling a gateway installed at the premises to the processor via a remote network that includes the first channel, wherein the plurality of devices is coupled to the gateway.

The method includes coupling the plurality of devices to the gateway using at least one of a wireless and a wired medium.

The method includes coupling an external power source to the plurality of devices of the device array and configuring the external power supply to supply power to the plurality of devices.

The method includes coupling the external power source to the gateway.

The method includes configuring the gateway to include the external power source.

The method includes configuring the external power source to include a Power-over-Ethernet device.

The method includes configuring each device to include an internal power supply coupled to the external power source.

The method includes configuring each device of the plurality of devices of the device array to include a housing comprising a communication device, and configured for installation in the premises.

The method includes configuring the housing for installation in a surface of the premises.

The surface includes at least one of a ceiling and a ceiling component, wherein the ceiling component includes at least one of a tile, plank, panel, drop panel, grate, grid, beam, and support structure.

The method includes configuring the communication device to include a radio frequency (RF) communication device.

The method includes configuring the communication device to include a Bluetooth device.

The method includes configuring each device to include an internal antenna coupled to the communication device, wherein the internal antenna includes a Bluetooth Low Energy antenna.

The method includes configuring each device to include an antenna coupled to the communication device.

The antenna comprises a low energy antenna.

The method includes configuring the housing to contain the communication device and the antenna.

The method includes configuring the housing for mounting at least one of in and through the surface.

The method includes configuring the housing to include a proximal end configured to be visible on the surface.

The method includes configuring each device to include circuitry coupled to the communication device, and an indicator coupled to the circuitry.

The method includes positioning the indicator adjacent the proximal end.

The method includes configuring the proximal end to include a translucent region adjacent the indicator.

The method includes configuring the circuitry to control a state of the indicator according to an operational state of the device.

The method includes configuring the state of the indicator to include a first state corresponding to a first operational state of the device, and a second state corresponding to a second operational state of the device.

The method includes configuring the indicator to include a visual indicator positioned adjacent to the proximal end of the housing.

The method includes configuring the visual indicator to include a light-emitting diode (LED) with a plurality of illumination states.

The method includes configuring the illumination states to include at least one of illuminated, off, at least one illumination level, at least one color, and alternating between a first state and a second state.

The method includes configuring the indicator to include an audible indicator positioned adjacent to the proximal end of the housing.

The method includes configuring each device to include an internal power supply coupled to the circuitry.

The method includes configuring each device to include a sensor coupled to the circuitry, wherein the sensor includes at least one of a location sensor, tracking sensor, asset tracking sensor, light sensor, temperature sensor, acoustic sensor, environmental sensor, life safety sensor, carbon dioxide sensor, air quality sensor, and life style sensor.

The mobile device includes at least one of a smart phone, a tablet computer, a smart watch, and a wearable computing device.

The premises includes at least one of a retail outlet, office, warehouse, healthcare facility, entertainment venue, transportation facility.

Embodiments include a device comprising a housing including a communication device, and configured for installation in a premises. The device includes circuitry in the housing coupled to the communication device. The circuitry is configured to control the communication device to communicate over a first channel with a plurality of mobile devices. Data of the communication is used to detect presence of the plurality of mobile devices in the premises. The circuitry is configured to communicate over the first channel with the plurality of mobile devices and over a second channel with a remote cloud device to track real-time position of the plurality of mobile devices in the premises.

Embodiments include a device comprising: a housing including a communication device, and configured for installation in a premises; and circuitry in the housing coupled to the communication device, wherein the circuitry is configured to control the communication device to communicate over a first channel with a plurality of mobile devices, wherein data of the communication is used to detect presence of the plurality of mobile devices in the premises, wherein the circuitry is configured to communicate over the first channel with the plurality of mobile devices and over a second channel with a remote cloud device to track real-time position of the plurality of mobile devices in the premises.

The circuitry is coupled to a gateway installed at the premises.

The gateway is coupled to the remote cloud device via a remote network.

The circuitry is coupled to the gateway using at least one of a wireless and a wired medium.

The device includes an external power source coupled to the circuitry and configured to supply power to the plurality of devices.

The external power source is coupled to the gateway.

The gateway includes the external power source.

The external power source comprises a Power-over-Ethernet device.

The device includes an internal power supply coupled to the external power source.

The communication device includes a radio frequency (RF) communication device.

The communication device includes a Bluetooth device.

The device includes an internal antenna coupled to the communication device.

The device includes an antenna coupled to the communication device.

The antenna comprises a Bluetooth low energy antenna.

The housing is configured to contain the communication device and the antenna.

The housing is configured for installation in a surface of the premises.

The surface includes at least one of a ceiling and a ceiling component, wherein the ceiling component includes at least one of a tile, plank, panel, drop panel, grate, grid, beam, and support structure.

The housing is configured for mounting at least one of in and through the surface.

The housing includes a proximal end configured to be visible on the surface.

The device includes an indicator coupled to the circuitry.

The indicator is positioned adjacent the proximal end, wherein the proximal end includes a translucent region adjacent the indicator.

The circuitry is configured to control a state of the indicator according to an operational state of the device, wherein the state of the indicator includes a first state corresponding to a first operational state of the device, and a second state corresponding to a second operational state of the device.

The indicator includes a visual indicator positioned adjacent to the proximal end of the housing.

The visual indicator includes a light-emitting diode (LED) with a plurality of illumination states, wherein the illumination states include at least one of illuminated, off, at least one illumination level, at least one color, and alternating between a first state and a second state.

The indicator includes an audible indicator positioned adjacent to the proximal end of the housing.

The device includes an internal power supply coupled to the circuitry.

The device includes a sensor coupled to the circuitry, wherein the sensor includes at least one of a location sensor, tracking sensor, asset tracking sensor, light sensor, temperature sensor, acoustic sensor, environmental sensor, life safety sensor, carbon dioxide sensor, air quality sensor, and life style sensor.

The plurality of mobile devices includes at least one of a smart phone, a tablet computer, a smart watch, and a wearable computing device.

The remote cloud device includes a platform program configured to detect the presence and track the real-time position of each mobile device using data of signals received from the mobile device.

The signals received from the mobile device are received via at least one of the communication device and a broadband coupling between the mobile device and the remote cloud device.

The broadband coupling includes at least one of a cellular coupling and a WiFi coupling.

Instead of the platform program being configured to track the real-time position, each mobile device is configured to track and provide to the platform program data of the real-time position.

The data of signals received from the mobile device includes signal strength data of the plurality of mobile devices.

The device includes an application configured to run on the plurality of mobile devices and communicate with the communication device.

The platform program is configured to detect the presence and track the real-time position of each mobile device using data from the mobile device application.

The communication device is configured to receive the data from the mobile device application.

The platform program is configured to detect the presence and track the real-time position of each mobile device using data representing the device.

Instead of the platform program being configured to track the real-time position, each mobile device is configured to track and provide to the platform program data of the real-time position.

The platform program is configured to control the device.

The platform program is configured to control a configuration of the device.

The platform program includes at least one of logical data of the device, logical addresses of the device, and physical location data of the device.

The platform program is configured to provision the device.

The provisioning comprises associating a logical address of the device with a physical location of the device.

The provisioning comprises first communications via a first channel between a provisioning device at the premises and the device.

The provisioning comprises second communications via a second channel between the provisioning device at the premises and the platform program.

The device includes a provisioning application configured to run on the provisioning device and to perform the first communications and the second communications.

The provisioning device includes at least one of a smart phone and a tablet computer.

The platform program generates a database of at least one of presence data of the detected presence and position data of the tracking.

The platform program is configured to output at least one report characterizing a set of data of the database.

The platform program includes a rules engine.

The platform program is configured to generate messages to the plurality of mobile devices by operating on at least one of the presence data and the position data with the rules engine.

The platform program is configured to selectively push the messages to the plurality of mobile devices in real-time based on the real-time positions of the plurality of mobile devices in the premises.

The platform program is configured to selectively generate in real-time a message to a mobile device based on the real-time position of that mobile device.

The platform program is configured to push in real-time the message to the mobile device using the real-time position of that mobile device.

Content of the message is related to at least one item adjacent the real-time position.

The platform program is configured to generate the messages using at least one of profile data corresponding to a mobile device and account data corresponding to the mobile device, wherein the profile data and the account data correspond to a user of the mobile device.

The premises includes at least one of a retail outlet, office, warehouse, healthcare facility, entertainment venue, transportation facility.

Embodiments include a method comprising configuring a housing to include a communication device, and configuring the housing for installation in a premises. The method includes configuring circuitry in the housing to couple to the communication device, and to control the communication device to communicate over a first channel with a plurality of mobile devices. Data of the communication is used to detect presence of the plurality of mobile devices in the premises. The method includes configuring the circuitry to track real-time position of the plurality of mobile devices in the premises by communicating over the first channel with the plurality of mobile devices and over a second channel with a remote cloud device.

Embodiments include a method comprising: configuring a housing to include a communication device, and configuring the housing for installation in a premises; configuring circuitry in the housing to couple to the communication device, and to control the communication device to communicate over a first channel with a plurality of mobile devices, wherein data of the communication is used to detect presence of the plurality of mobile devices in the premises; and configuring the circuitry to track real-time position of the plurality of mobile devices in the premises by communicating over the first channel with the plurality of mobile devices and over a second channel with a remote cloud device.

The method includes coupling the circuitry to a gateway installed at the premises.

The method includes coupling the gateway to the remote cloud device via a remote network.

The method includes coupling the circuitry to the gateway using at least one of a wireless and a wired medium.

The method includes coupling an external power source to the circuitry to supply power to the plurality of devices.

The method includes coupling the external power source to the gateway.

The method includes configuring the gateway to include the external power source.

The external power source comprises a Power-over-Ethernet device.

The method includes coupling an internal power supply to the external power source.

The method includes configuring the communication device to include a radio frequency (RF) communication device.

The method includes configuring the communication device to include a Bluetooth device.

The method includes coupling an internal antenna to the communication device.

The method includes coupling an antenna to the communication device.

The method includes configuring the antenna as a Bluetooth low energy antenna.

The method includes configuring the housing to contain the communication device and the antenna.

The method includes configuring the housing for installation in a surface of the premises.

The surface includes at least one of a ceiling and a ceiling component, wherein the ceiling component includes at least one of a tile, plank, panel, drop panel, grate, grid, beam, and support structure.

The method includes configuring the housing for mounting at least one of in and through the surface.

The method includes configuring the housing to include a proximal end configured to be visible on the surface.

The method includes coupling an indicator to the circuitry.

The method includes positioning the indicator adjacent the proximal end, and configuring the proximal end to include a translucent region adjacent the indicator.

The method includes configuring the circuitry to control a state of the indicator according to an operational state of the device, wherein the state of the indicator includes a first state corresponding to a first operational state of the device, and a second state corresponding to a second operational state of the device.

The method includes configuring the indicator to include a visual indicator positioned adjacent to the proximal end of the housing.

The method includes configuring the visual indicator to include a light-emitting diode (LED) with a plurality of illumination states, wherein the illumination states include at least one of illuminated, off, at least one illumination level, at least one color, and alternating between a first state and a second state.

The method includes configuring the indicator to include an audible indicator positioned adjacent to the proximal end of the housing.

The method includes coupling an internal power supply to the circuitry.

The method includes coupling a sensor to the circuitry, wherein the sensor includes at least one of a location sensor, tracking sensor, asset tracking sensor, light sensor, temperature sensor, acoustic sensor, environmental sensor, life safety sensor, carbon dioxide sensor, air quality sensor, and life style sensor.

The plurality of mobile devices includes at least one of a smart phone, a tablet computer, a smart watch, and a wearable computing device.

The method includes configuring the remote cloud device to include a platform program configured to detect the presence and track the real-time position of each mobile device using data of signals received from the mobile device.

The method includes configuring at least one of the communication device and a broadband coupling between the mobile device and the remote cloud device to receive the signals from the mobile device.

The method includes configuring the broadband coupling to include at least one of a cellular coupling and a WiFi coupling.

Instead of configuring the platform program to track the real-time position, configuring each mobile device to track and provide to the platform program data of the real-time position.

The data of signals received from the mobile device includes signal strength data of the plurality of mobile devices.

The method includes configuring an application to run on the plurality of mobile devices and communicate with the communication device.

The method includes configuring the platform program to detect the presence and track the real-time position of each mobile device using data from the mobile device application.

The method includes configuring the communication device to receive the data from the mobile device application.

The method includes configuring the platform program to detect the presence and track the real-time position of each mobile device using data representing the device.

Instead of configuring the platform program to track the real-time position, configuring each mobile device to track and provide to the platform program data of the real-time position.

The method includes configuring the platform program to control the device.

The method includes configuring the platform program to control a configuration of the device.

The method includes configuring the platform program to include at least one of logical data of the device, logical addresses of the device, and physical location data of the device.

The method includes configuring the platform program to provision the device.

The provisioning comprises associating a logical address of the device with a physical location of the device.

The provisioning comprises first communications via a first channel between a provisioning device at the premises and the device.

The provisioning comprises second communications via a second channel between the provisioning device at the premises and the platform program.

The method includes configuring a provisioning application to run on the provisioning device and to perform the first communications and the second communications.

The provisioning device includes at least one of a smart phone and a tablet computer.

The method includes configuring the platform program to generate a database of at least one of presence data of the detected presence and position data of the tracking.

The method includes configuring the platform program to output at least one report characterizing a set of data of the database.

The method includes configuring the platform program to include a rules engine.

The method includes configuring the platform program to generate messages to the plurality of mobile devices by operating on at least one of the presence data and the position data with the rules engine.

The method includes configuring the platform program to selectively push the messages to the plurality of mobile devices in real-time based on the real-time positions of the plurality of mobile devices in the premises.

The method includes configuring the platform program to selectively generate in real-time a message to a mobile device based on the real-time position of that mobile device.

The method includes configuring the platform program to push in real-time the message to the mobile device using the real-time position of that mobile device.

The method includes configuring content of the message to relate to at least one item adjacent the real-time position.

The method includes configuring the platform program to generate the messages using at least one of profile data corresponding to a mobile device and account data corresponding to the mobile device, wherein the profile data and the account data correspond to a user of the mobile device.

The premises includes at least one of a retail outlet, office, warehouse, healthcare facility, entertainment venue, transportation facility.

The inventions and methods described herein can be viewed as a whole, or as a number of separate inventions that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Various aspects of the invention are described herein with reference to drawings that are schematic illustrations of idealized configurations of the present invention. As such, variations from the shapes of the illustrations resulting from manufacturing techniques, tolerances, etc., are to be expected. Thus, the various aspects of the invention presented throughout this disclosure should not be construed as limited to the particular shapes of elements (e.g., transmission modules, processor modules, receiving modules, memory modules, etc.) illustrated and described herein, but are to include deviations in shapes that result, for example, from manufacturing. By way of example, an element illustrated or described as a rectangle may have rounded or curved features and/or a gradient concentration at its edges rather than a discrete change from one element to another.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements disclosed as being on the “lower” side of other elements would then be oriented on the “upper” side of the other elements. The term “lower” can therefore encompass both an orientation of “lower” and “upper,” depending on the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Furthermore, various descriptive terms used herein, such as “transmitter” and “receiver,” should be given the broadest meaning possible within the context of the present disclosure. It will be understood that when an element such as a region, layer, section, substrate, or the like, is referred to as being “coupled” another element, it can be directly connected to the other element or intervening elements may also be present. In contrast, when an element is referred to as being “directly connected” another element, there are no intervening elements present.

1. A system comprising:
a device array comprising a plurality of devices installed in a surface that forms a portion of a premises, wherein each device includes a communication device configured to communicate with a plurality of mobile devices at the premises; and
a cloud platform coupled to the device array via a remote network, wherein the cloud platform is remote to the premises and includes a platform program configured to use device array data from the plurality of devices to detect presence and track real-time position of the plurality of mobile devices in the premises.

2. The system of claim 1, wherein the surface includes at least one of a ceiling and a ceiling component, wherein the ceiling component includes at least one of a tile, plank, panel, drop panel, grate, grid, beam, and support structure.

3. The system of claim 1, comprising a gateway installed at the premises and coupled to the cloud device via the remote network, wherein the plurality of devices is coupled to the gateway.

4. The system of claim 3, wherein the plurality of devices is coupled to the gateway using at least one of a wireless and a wired medium.

5. The system of claim 3, comprising an external power source coupled to the plurality of devices of the device array and configured to supply power to the plurality of devices.

6. The system of claim 5, wherein the external power source is coupled to the gateway.

7. The system of claim 5, wherein the gateway includes the external power source.

8. The system of claim 5, wherein the external power source comprises a Power-over-Ethernet device.

9. The system of claim 5, wherein each device includes an internal power supply coupled to the external power source.

10. The system of claim 1, wherein the communication device includes a radio frequency (RF) communication device.

11. The system of claim 1, wherein the communication device includes a Bluetooth device.

12. The system of claim 11, wherein each device comprises an internal antenna coupled to the communication device, wherein the internal antenna includes a Bluetooth Low Energy antenna.

13. The system of claim 1, wherein each device includes an antenna coupled to the communication device.

14. The system of claim 13, wherein the antenna comprises a Bluetooth low energy antenna.

15. The system of claim 13, wherein each device includes a housing configured to contain the communication device and the antenna.

16. The system of claim 15, wherein the housing is configured for mounting at least one of in and through the surface.

17. The system of claim 15, wherein the housing includes a proximal end configured to be visible on the surface.

18. The system of claim 17, wherein each device includes circuitry coupled to the communication device, and an indicator coupled to the circuitry.

19. The system of claim 18, wherein the indicator is positioned adjacent the proximal end, wherein the proximal end includes a translucent region adjacent the indicator.

20. The system of claim 18, wherein the circuitry is configured to control a state of the indicator according to an operational state of the device, wherein the state of the indicator includes a first state corresponding to a first operational state of the device, and a second state corresponding to a second operational state of the device.

21-60. (canceled)
